(19) United States
(12) Patent Application Publication
(10) Pub. No.: US 2002/0039113 A1
(43) Pub. Date: Apr. 4, 2002

(54) Virtual-grave-visiting method and virtual-grave-visiting system

(76) Inventor: Junichi Kawahara, Tokyo (JP)

Correspondence Address: OSTROLENK FABER GERB & SOFFEN, 1180 AVENUE OF THE AMERICAS, NEW YORK, NY, 100368403

(21) Appl. No.: 09/903,894

(22) Filed: Jul. 12, 2001

(30) Foreign Application Priority Data
Jul. 24, 2000 (JP) 2000-221927
Mar. 21, 2001 (JP) 2001-079744

(51) Int. Cl. G09G 5/00

(52) U.S. Cl. 345/706; 709/224

(57) ABSTRACT

Grave-visiting-page-transmitting means 12 transmits a grave-visiting page containing gravestone image and manner icons to visitor terminal 3 by retrieving customer database 4. When one of manner icons is clicked on the grave-visiting page, manner-content-selection-page-transmitting means 13 makes a manner-content-selection page by retrieving the manner database 5 and transmits it to the visitor terminal 3. When one or more manner contents are selected on the manner-content-selection page, manner-applet-transmitting means 14 retrieves one or more manner applets from the manner database 5 and transmits them to the visitor terminal 3. Historical-data-recording means 15 records historical data containing account result in the historical database 6.

### FIELD OF THE INVENTION AND RELATED ART STATEMENT

This invention relates to the virtual-grave-visiting method and a virtual-grave-visiting system, in particular to a virtual-grave-visiting method and a virtual-grave-visiting system that utilize the Internet.

From ancient times, graves have been built so as to dedicate to ancestors and the decedent, but troubles and labors of grave visiting by visitors (for example, posterity) are not a little regularly.

So an example of the grave-visiting system which reduced one part of such as troubles and labors of grave visiting is disclosed by Japanese Patent Publication No. Heisei 10(1998)-105615. This grave-visiting system was able to store each information that is needed at grave visiting, such as the decedent data, lineage data or the like in memory, and read out and display them on display under certain conditions. In addition, it was able to store multimedia data, such as image of gravestone, voice of the decedent, sutra chanting, in memory, and read out them from the memory under certain conditions.

However, the conventional grave-visiting system stated above was basically no more than a computer system in which paper-recorded information was picked up and kept in the custody of temples, cemeteries or the like. So, it did not solve troubles and labors for coming and going to a graveyard. In particular, when the graveyard located in the remote place from residence of a visitor, it needed time and expense to come and go to the graveyard, and so that the visitor's burden of grave visiting was not become much lighter.

In addition, although it could be a streamlining of office work for temples, cemeteries or the like to manage a graveyard to introduce a computer system, it was hard to be an incentive to put paper-recorded information with the computer system.

### OBJECT AND SUMMARY OF THE INVENTION

It is the first object of this invention to provide a virtual-grave-visiting method, in which a visitor can visit a grave by accessing a virtual-graveyard server from a visitor terminal via the Internet.

It is the second object of this invention to provide a virtual-grave-visiting method, in which entrance fee can be accounted when the visitor enters into the virtual graveyard.

It is the third object of this invention to provide a virtual-grave-visiting method, in which various manners for grave visiting can be virtually executed by accessing a virtual-graveyard server via the Internet, and manner fees can be accounted with every manner.

It is the fourth object of this invention to provide a virtual-grave-visiting method, in which a grave-visiting agent can vicariously execute various manners for grave visiting to a real gravestone.

It is the fifth object of this invention to provide a virtual-grave-visiting system, in which a customer can select vicarious execution or virtual execution of grave visiting on the basis of importance of grave-visiting day.

It is the sixth object of this invention to provide a virtual-grave-visiting system, in which a visitor can designate a grave-visiting agent beforehand.

It is the seventh object of this invention to provide a virtual-grave-visiting system, which informs a grave-visiting agent terminal of vicarious execution of grave visiting via the Internet when the vicarious execution of grave visiting is selected on a grave-visiting page.

It is the eighth object of this invention to provide a virtual-grave-visiting system to realize the above virtual-grave-visiting method.

It is the ninth object of this invention to provide a virtual-graveyard server to realize the above virtual-grave-visiting method.

It is the tenth object of this invention to provide a program to realize the above-mentioned virtual-graveyard server.

According to this invention, troubles and labors of coming and going to a graveyard become needless because a visitor does not have to proceed to a graveyard. In particular, visitor's burden of grave visiting have become much lighter, because expense and time of coming and going to a graveyard becomes needless even if a visitor cannot leave the residence thereof when a graveyard is located in the remote place.

In addition, a visitor can selectively execute various manners for grave visiting as the occasion demands, because various manner contents for grave visiting can be easily chosen on a grave-visiting page. For example, the visitor can execute only a few manner contents for grave visiting every a month, and can execute many manner contents for grave visiting on memorial days in a year.

Furthermore, a visitor can selectively use vicarious execution or virtual execution of grave visiting according to importance, because the visitor can select vicarious execution or virtual execution of grave visiting on a grave-visiting page. For example, the visitor can select vicarious execution of grave visiting on important days such as an anniversary of the decedent, the Bon festival, the equinoctial week, and he can select virtual execution of grave visiting on the day that is not important.

A visitor can designate a grave-visiting agent beforehand because a virtual-graveyard server informs vicarious execution of grave visiting to a grave-visiting agent terminal via the Internet. In addition, a manager of a virtual-graveyard server can entrust a grave-visiting agent who existed in local to vicarious execution of grave visiting.

On the other hand, grave-visiting agents can improve customer services by doing vicarious execution of grave visiting on the spot on the basis of information of a vicarious execution of grave visiting.

### BRIEF DESCRIPTION OF THE DRAWING

FIG. 1 is a block diagram of a virtual-grave-visiting system according to the first embodiment of this invention.

FIG. 2 is a screen view of a virtual-graveyard homepage displayed by a visitor terminal in FIG. 1.

FIG. 3 is a screen view of a grave-visiting page displayed by a visitor terminal in FIG. 1.

FIG. 4 is a screen view of a grave-cleaning-content-selection page displayed by a visitor terminal when the grave-cleaning icon is clicked on the grave-visiting page of FIG. 3.

FIG. 5 is a screen view of an incense-burning-content-selection page displayed by a visitor terminal when the incense-burning icon is clicked on the grave-visiting page of FIG. 3.

FIG. 6 is a screen view of a votive-offering-content-selection page displayed by a visitor terminal when the votive-offering icon is clicked on the grave-visiting page of FIG. 3.

FIG. 7 is a screen view of a sutra-chanting-content-selection page displayed by a visitor terminal when the sutra-chanting icon is clicked on the grave-visiting page of FIG. 3.

FIG. 8 is a screen view of the decedent-displaying-content-selection page displayed by a visitor terminal when the decedent-displaying icon is clicked on the grave-visiting page of FIG. 3.

FIG. 9 is a screen view of a grave-visiting page after selecting various manners for grave visiting on the grave-visiting page of FIG. 3.

FIG. 10 shows customer records of the customer database in FIG. 1.

FIG. 11 shows the decedent records of the decedent file in FIG. 10.

FIG. 12 shows various manner files in the manner database in FIG. 1.

FIG. 13 shows grave-cleaning records of the grave-cleaning file in FIG. 12.

FIG. 14 shows incense-burning records of the incense-burning file in FIG. 12.

FIG. 15 shows votive-offering records of the votive-offering file in FIG. 12.

FIG. 16 shows sutra-chanting records of the sutra-chanting file in FIG. 12.

FIG. 17 shows historical-data records of the historical database in FIG. 1.

FIG. 18 is a flowchart of process of the virtual-graveyard server in FIG. 1.

FIG. 19 is a block diagram of a virtual-grave-visiting system according to the second embodiment of this invention.

FIG. 20 is a screen view of a virtual-graveyard homepage displayed by a visitor terminal in FIG. 19.

FIG. 21 shows historical-data records of the historical database in FIG. 19.

FIG. 22 is a flowchart of process of the virtual-graveyard server in FIG. 19.

FIG. 23 is a screen view of a grave-visiting page displayed by a visitor terminal in the third and the fourth embodiments of this invention.

FIG. 24 is a block diagram of a virtual-grave-visiting system according to the third embodiment of this invention.

FIG. 25 is a flowchart of process of the virtual-graveyard server in FIG. 24.

FIG. 26 is a block diagram of a virtual-grave-visiting system according to the fourth embodiment.

FIG. 27 is a flowchart of process of the virtual-graveyard server in FIG. 26.

FIG. 28 is a block diagram of a virtual-grave-visiting system according to the fifth embodiment of this invention.

FIG. 29 is a screen view of a grave-visiting page displayed by a visitor terminal in FIG. 28.

FIG. 30 is a screen view of a grave-cleaning-content-selection page displayed by a visitor terminal when the grave-cleaning icon is clicked on the grave-visiting page of FIG. 29.

FIG. 31 is a screen view of an incense-burning-content-selection page displayed by a visitor terminal when the incense-burning icon is clicked on the grave-visiting page of FIG. 29.

FIG. 32 is a screen view of a votive-offering-content-selection page displayed by a visitor terminal when the votive-offering icon is clicked on the grave-visiting page of FIG. 29.

FIG. 33 is a screen view of a sutra-chanting-content-selection page displayed by a visitor terminal when the sutra-chanting icon is clicked on the grave-visiting page of FIG. 29.

FIG. 34 is a screen view of the decedent-displaying-content-selection page displayed by a visitor terminal when the decedent-displaying icon is clicked on the grave-visiting page of FIG. 29.

FIG. 35 is a screen view of a grave-visiting page after selecting various manners for grave visiting on the grave-visiting page of FIG. 29.

FIG. 36 shows customer records of the customer database in FIG. 28.

FIG. 37 shows grave-cleaning records of the grave-cleaning file in the fifth embodiment.

FIG. 38 shows incense-burning records of the incense-burning file in the fifth embodiment.

FIG. 39 shows votive-offering records of the votive-offering file in the fifth embodiment.

FIG. 40 shows sutra-chanting records of the sutra-chanting file in the fifth embodiment.

FIG. 41 shows historical-data records of the historical database in FIG. 28.

FIG. 42 is a flowchart of process of the virtual-graveyard server in FIG. 28.

FIG. 43 is a block diagram of a virtual-grave-visiting system according to the sixth embodiment of this invention.

FIG. 44 shows historical-data records of the historical database in FIG. 43.

FIG. 45 is a flowchart of process of the virtual-graveyard server in FIG. 43.

FIG. 46 is a screen view of a grave-visiting page displayed by a visitor terminal in FIG. 43.

FIG. 47 is a block diagram of a virtual-grave-visiting system according to the seventh embodiment of this invention.

FIG. 48 is a flowchart of process of the virtual-graveyard server in FIG. 47.

FIG. 49 is a block diagram of a virtual-grave-visiting system according to the eighth embodiment of this invention.

FIG. 50 is a flowchart of process of the virtual-graveyard server in FIG. 49.

### DETAILED DESCRIPTION OF PREFERRED EMBODIMENTS

(1) First Embodiment

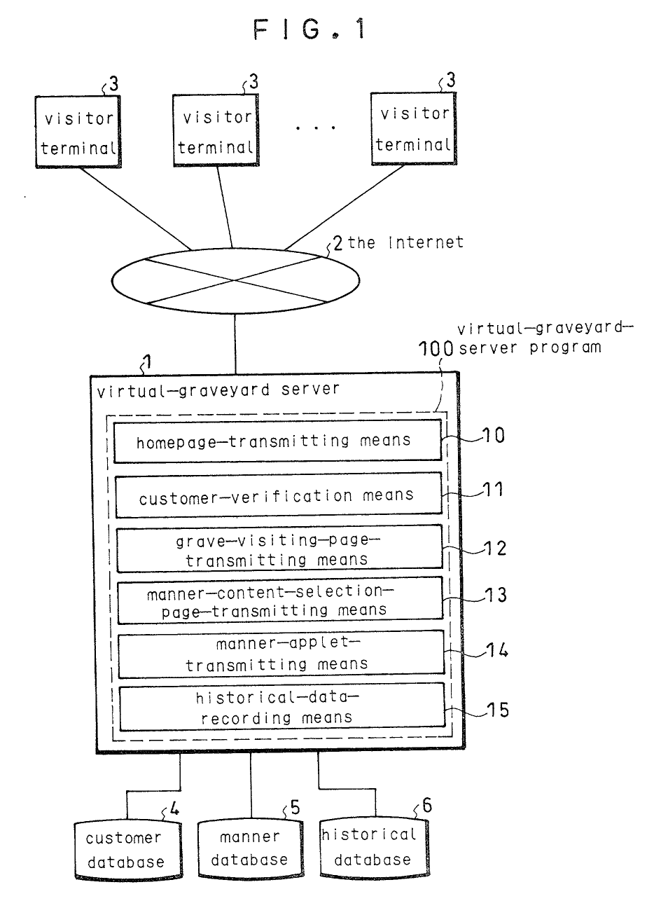

FIG. 1 is a block diagram of a virtual-grave-visiting system according to the first embodiment of this invention. The main part thereof comprises a virtual-graveyard server 1, one or more visitor terminals 3 connected to the virtual-graveyard server 1 via the Internet 2, and a customer database 4, a manner database 5 and a historical database 6 connected to the virtual-graveyard server 1.

The virtual-graveyard server 1 is a server computer for temple, cemetery, grave-visiting agent or the like to manage a virtual graveyard. The installation place thereof is not matter so long as it is connected to the Internet 2. The virtual-graveyard server 1 is loaded with a network operating system (not shown), a database management system (not shown) etc.

The virtual-graveyard server 1 is also loaded with a virtual-graveyard-server program 100, which comprises a homepage-transmitting means 10, a customer-verification means 11, a grave-visiting-page-transmitting means 12, a manner-content-selection-page-transmitting means 13, a manner-applet-transmitting means 14, and a historical-data-recording means 15.

The homepage-transmitting means 10 transmits a virtual-graveyard homepage to a visitor terminal 3 when the virtual-graveyard server 1 is accessed from the visitor terminal 3 via the Internet 2.

The customer-verification means 11 verifies whether a visitor is one of registered customers or not when the virtual-graveyard server 1 receives a grave-visiting request from a visitor terminal 3 via the Internet 2.

The grave-visiting-page-transmitting means 12 transmits a grave-visiting page containing a gravestone image and various manner icons to a visitor terminal 3 by retrieving the gravestone image from the customer database 4 when the customer-verification means 11 verifies that a visitor is one of registered customers.

The manner-content-selection-page-transmitting means 13 transmits a manner-content-selection page to a visitor terminal 3 by retrieving manner-content records from the manner database 5 when one of manner icons is clicked on the grave-visiting page displayed by the visitor terminal 3.

The manner-applet-transmitting means 14 transmits one or more manner applets to a visitor terminal 3 by retrieving them from the manner database 5 when one or more manner contents are selected on the manner-content-selection page displayed by the visitor terminal 3.

The historical-data-recording means 15 records historical data in the historical database 6 by referencing the manner database 5 when the grave-visiting page is transmitted by the grave-visiting-page-transmitting means 12 and when one or more manner applets are transmitted by the manner-applet-transmitting means 14.

A visitor terminal 3 is a terminal machine with a browser. Various kinds of information machines, such as personal computers, game machines, information household electric appliances, personal digital assistants, cellular phones or the like, can be used as a visitor terminal 3. No dedicated application program except a browser is particularly needed.

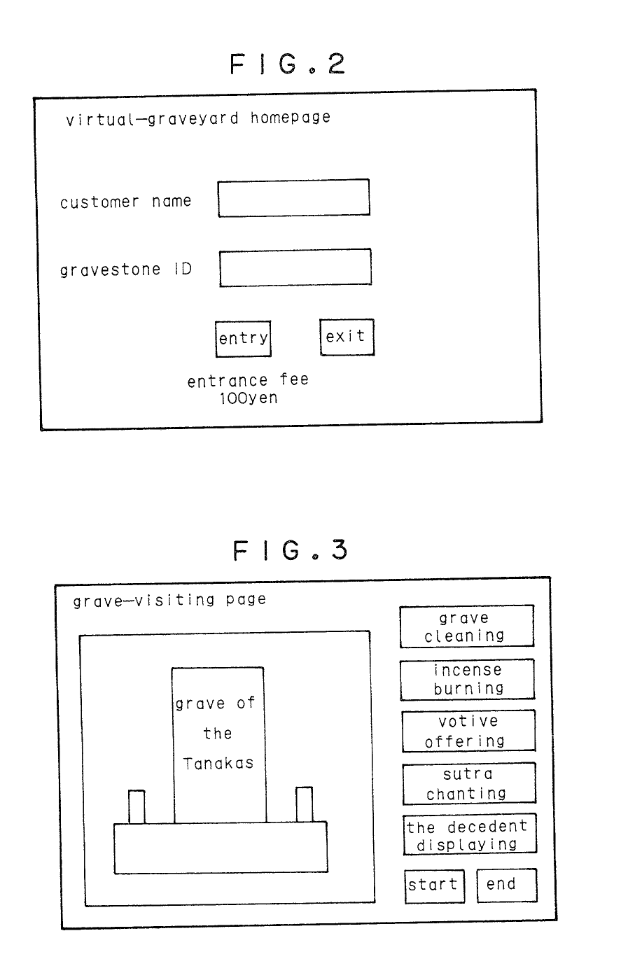

FIG. 2 is a screen view of the virtual-graveyard homepage displayed by a visitor terminal 3 when the virtual-graveyard server 1 is accessed from the visitor terminal 3 via the Internet 2. The virtual-graveyard homepage contains a field to input a customer name, a field to input a gravestone identifier (hereinafter referred to as gravestone ID), an entry icon and an exit icon. It is displayed that entrance fee should be accounted.

FIG. 3 is a screen view of a grave-visiting page displayed by a visitor terminal 3 when the entry icon is clicked after having input a customer name and a gravestone ID on the virtual-graveyard homepage of FIG. 2. The grave-visiting page contains a gravestone image, a grave-cleaning icon, an incense-burning icon, a votive-offering icon, a sutra-chanting icon, the decedent-displaying icon, a start icon and an end icon. The gravestone image may be well an image made with computer-generated graphics or a movie in addition to a photograph image of a gravestone taken on the spot. It may be assumed that a gravestone image can be turn in all directions in response to the visitor's operation by utilizing three-dimensional picture painting technology. Grave cleaning, incense burning, votive offering, sutra chanting and the decedent displaying are memorial services executed at the time of grave visiting, and hereinafter they are generally referred to as manners.

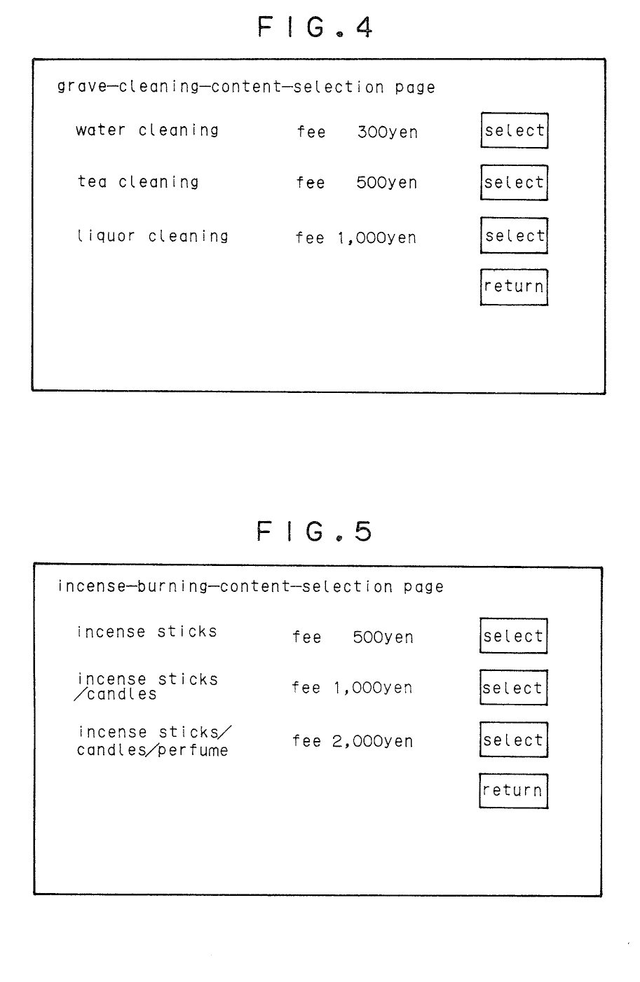

FIG. 4 is a screen view of a grave-cleaning-content-selection page displayed by a visitor terminal 3 when the grave-cleaning icon is clicked on the grave-visiting page of FIG. 3. The grave-cleaning-content-selection page contains each grave-cleaning content (water cleaning, tea cleaning and liquor cleaning), fee of each content, select icon of each content and a return icon. Water cleaning means cleaning only with water, tea cleaning means cleaning with water including tea, and liquor cleaning means cleaning with water including liquor.

FIG. 5 is a screen view of an incense-burning-content-selection page displayed by a visitor terminal 3 when the incense-burning icon is clicked on the grave-visiting page of FIG. 3. The incense-burning-content-selection page contains each incense-burning content (incense sticks, incense sticks/candles and incense sticks/candles/perfume), fee of each content, select icon of each content and a return icon.

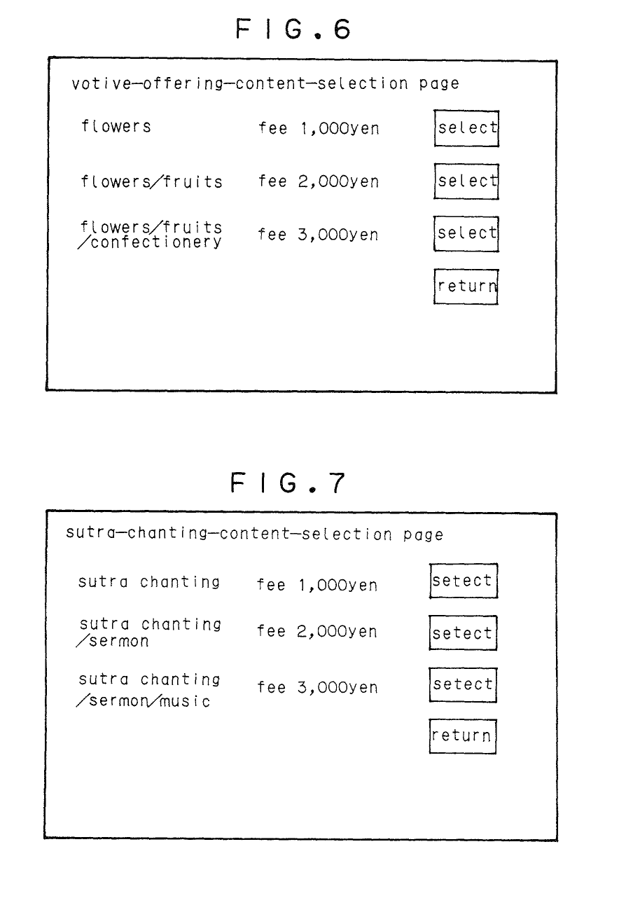

FIG. 6 is a screen view of a votive-offering-content-selection page displayed by a visitor terminal 3 when the votive-offering icon is clicked on the grave-visiting page of FIG. 3. The votive-offering-content-selection page contains each votive-offering content (flowers, flowers/fruits and flowers/fruits/confectionery), fee of each content, select icon of each content and a return icon.

FIG. 7 is a screen view of a sutra-chanting-content-selection page displayed by a visitor terminal 3 when the sutra-chanting icon is clicked on the grave-visiting page of FIG. 3. The sutra-chanting-content-selection page contains each sutra-chanting content (sutra chanting, sutra chanting/sermon and sutra chanting/sermon/music), fee of each content, select icon of each content and a return icon.

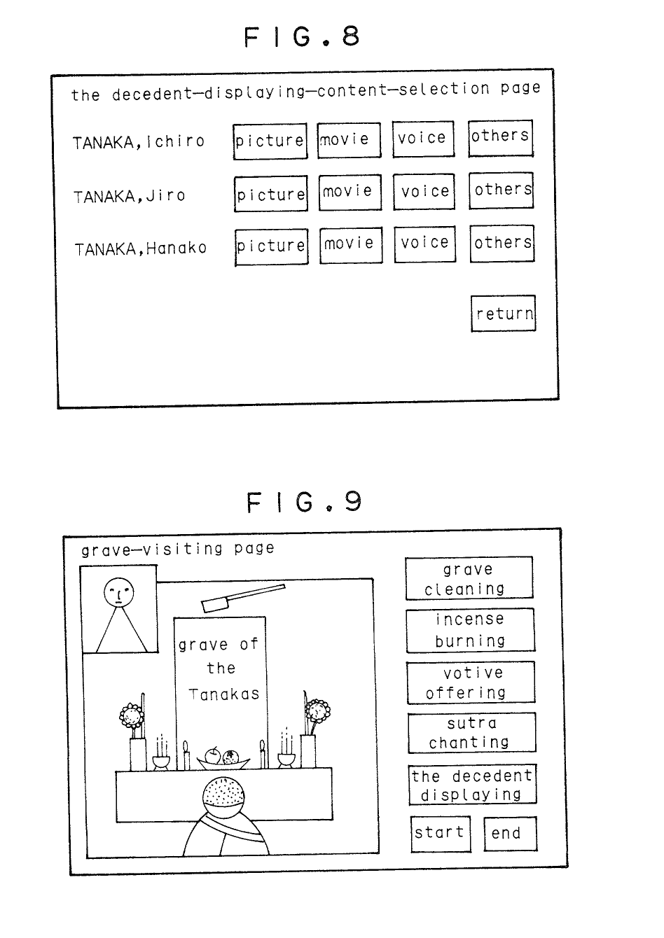

FIG. 8 is a screen view of the decedent-displaying-content-selection page displayed by a visitor terminal 3 when the decedent-displaying icon is clicked on the grave-visiting page of FIG. 3. The decedent-displaying-content-selection page contains one or more names of the decedent worshiped by a grave, select icons of picture, movie, voice and others of each the decedent and a return icon. When the others icons are clicked, a will, a resume (for example, an autobiography, a meritorious deed, a medical historical data etc.), gene information (for example, information or deposit number of DNA (DeoxyriboNucleic Acid), sperm or ovum) or the like can be referred to.

FIG. 9 is a screen view of the grave-visiting page after various manners for grave visiting are selected with various manner icons on the grave-visiting page. Images of ladle, incense sticks, candles, flowers, fruits and back figure of a priest are added to the gravestone image on the grave-visiting page of FIG. 3, and more a window displaying a picture of the decedent (the decedent-displaying window) is opened.

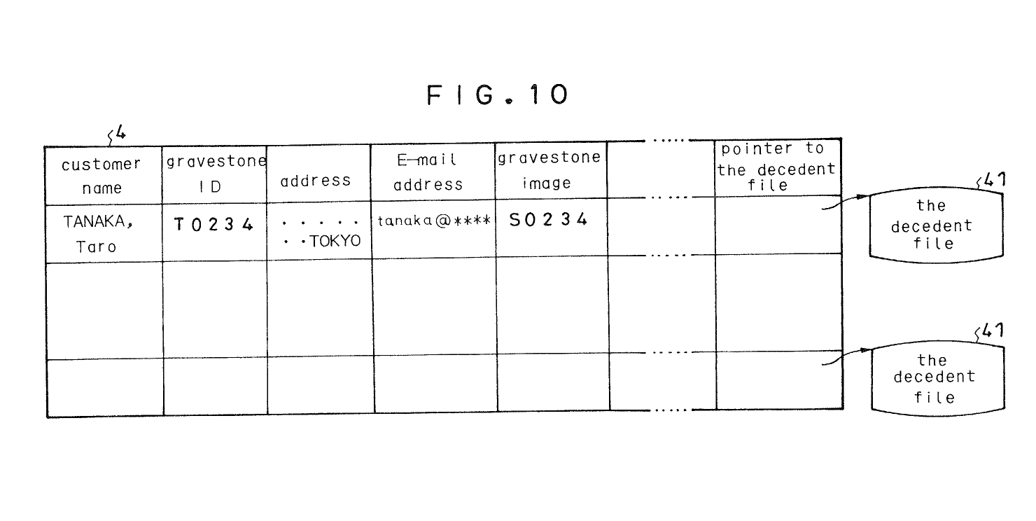

Referring to FIG. 10, the customer database 4 stores one or more customer records, each of which has each field of customer name, gravestone ID, address, E-mail address, gravestone image (or file name, file pointer thereof etc.), pointer to the decedent file etc. Each pointer to the decedent file points to each of the decedent file 41. only temples, cemeteries and grave-visiting agents (hereinafter generally referred to as grave-visiting agents) can register or correct customer data in the customer database 4 based on prior request from a customer. Because customer data in the customer database 4 should not be updated unfairly by unjust access from a visitor terminal 3. In addition, there is an advantage to be able to collect subscription fee to the virtual graveyard and office work fee surely.

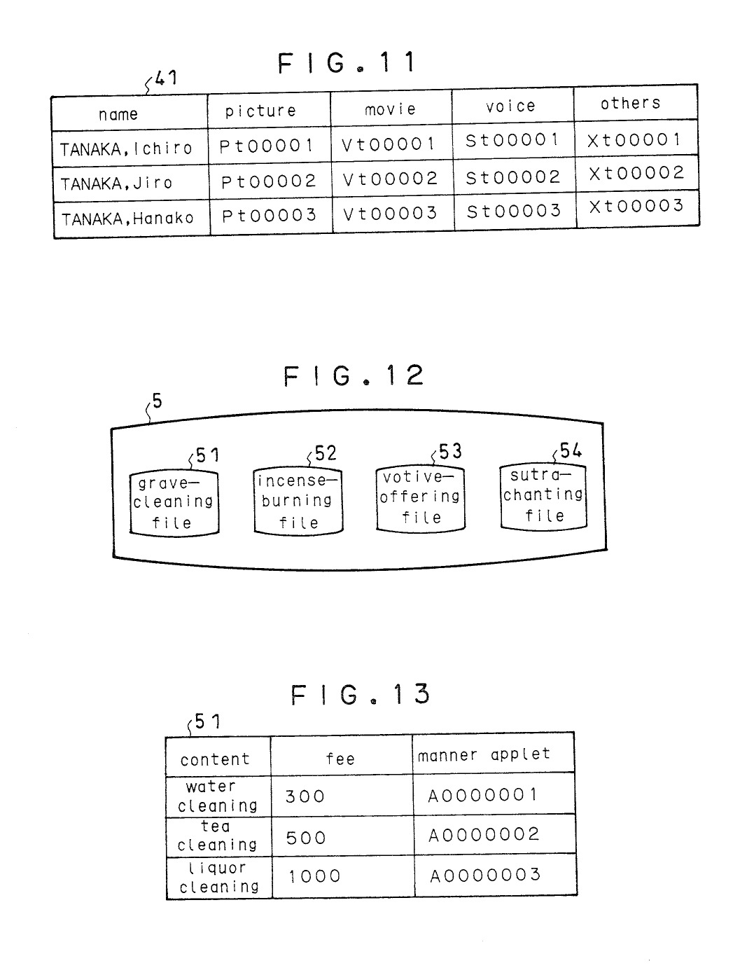

Referring to FIG. 11, the decedent file 41 stores one or more the decedent records, one of which has each field of the decedent name, picture, movie, voice and others. Instead of picture, movie, voice and others, file name or file pointer thereof can be stored.

As shown in FIG. 12, the manner database 5 contains a grave-cleaning file 51, an incense-burning file 52, a votive-offering file 53, and a sutra-chanting file 54.

Referring to FIG. 13, the grave-cleaning file 51 stores one or more grave-cleaning records, one of which has each field of each content of grave cleaning (water cleaning, tea cleaning and liquor cleaning), fee of each content and small program to execute each content by the visitor terminal 3. The small programs are hereinafter referred to as manner applets. It is desirable for manner applet to be made by object-oriented language without hardware dependency, for example, JAVA (registered trademark of Sun Microsystems). Instead of manner applet itself, file name or file pointer thereof can be stored (like as follows)

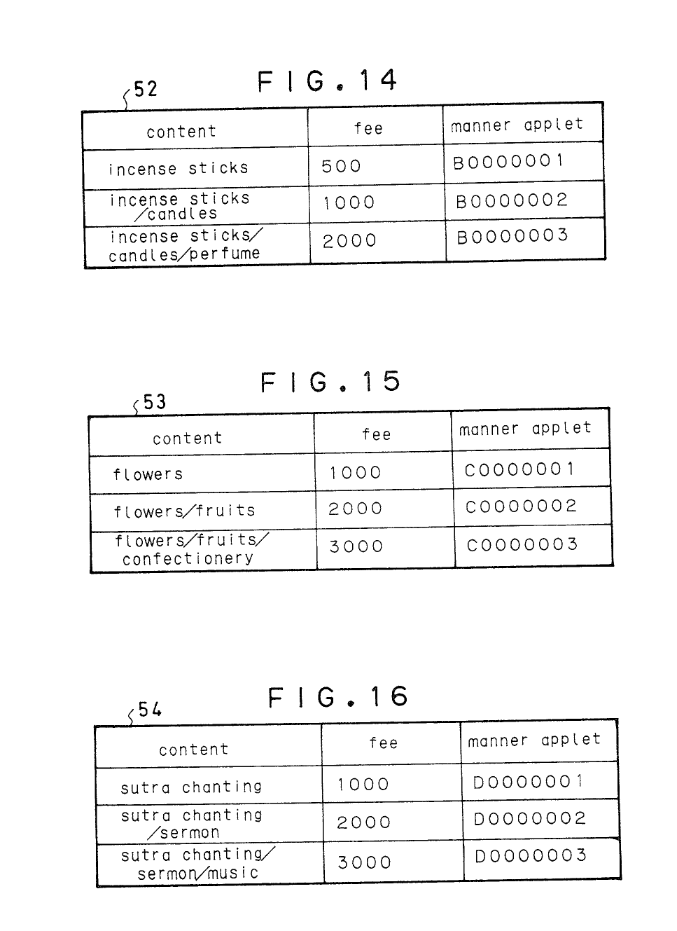

Referring to FIG. 14, the incense-burning file 52 stores one or more incense-burning records, one of which has each field of each content of incense burning (incense sticks, incense sticks/candles and incense sticks/candles/perfume), fee of each content and manner applet of each content.

Referring to FIG. 15, the votive-offering file 53 stores one or more votive-offering records, one of which has each field of each content of votive offering (flowers, flowers/fruits and flowers/fruits/confectionery), fee of each content and manner applet of each content.

Referring to FIG. 16, the sutra-chanting file 54 stores one or more sutra-chanting records, one of which has each field of each content of sutra-chanting (sutra chanting, sutra chanting/sermon and sutra chanting/sermon/music), fee of each content and manner applet of each content.

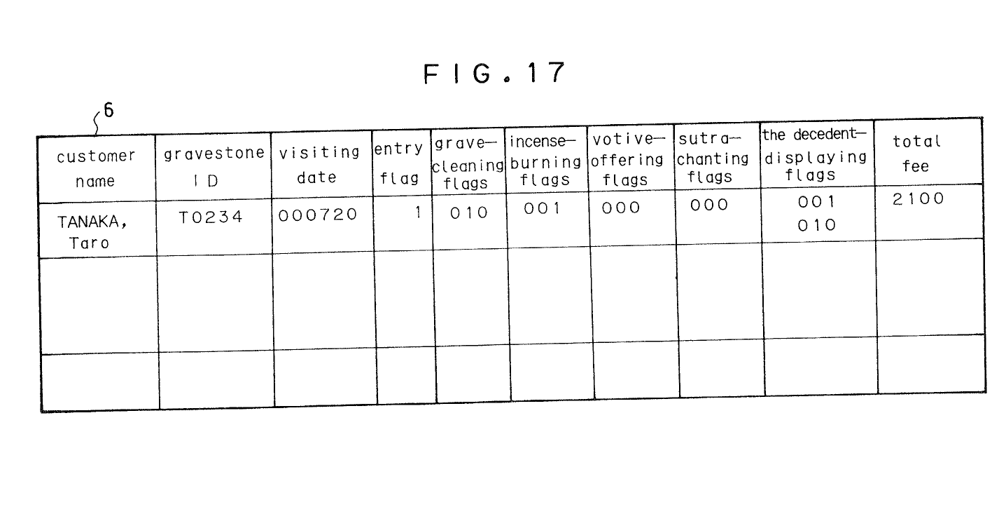

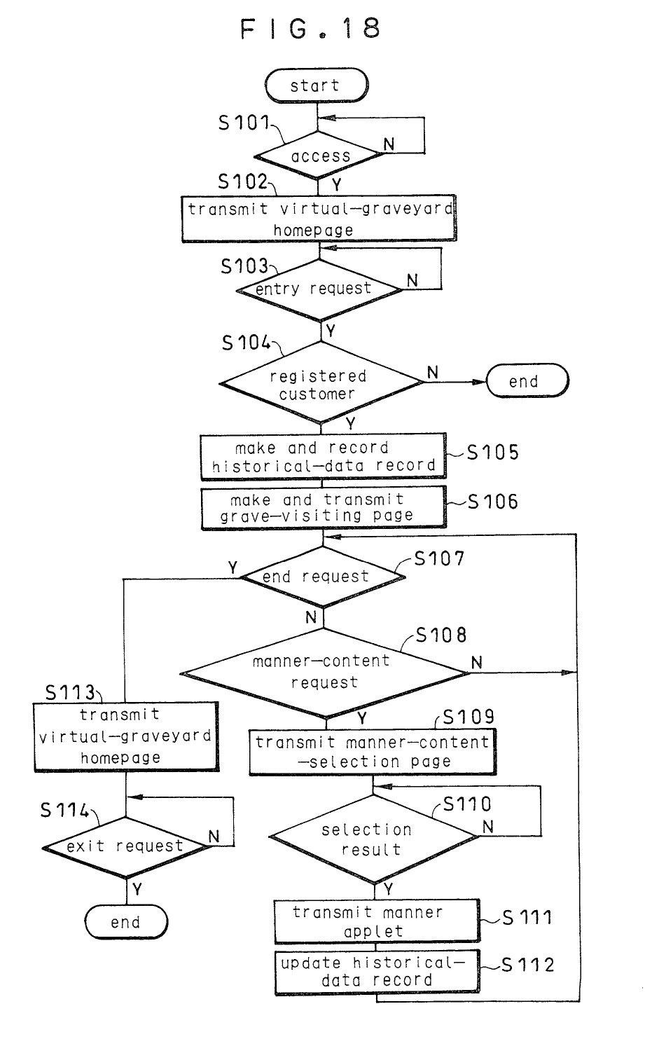

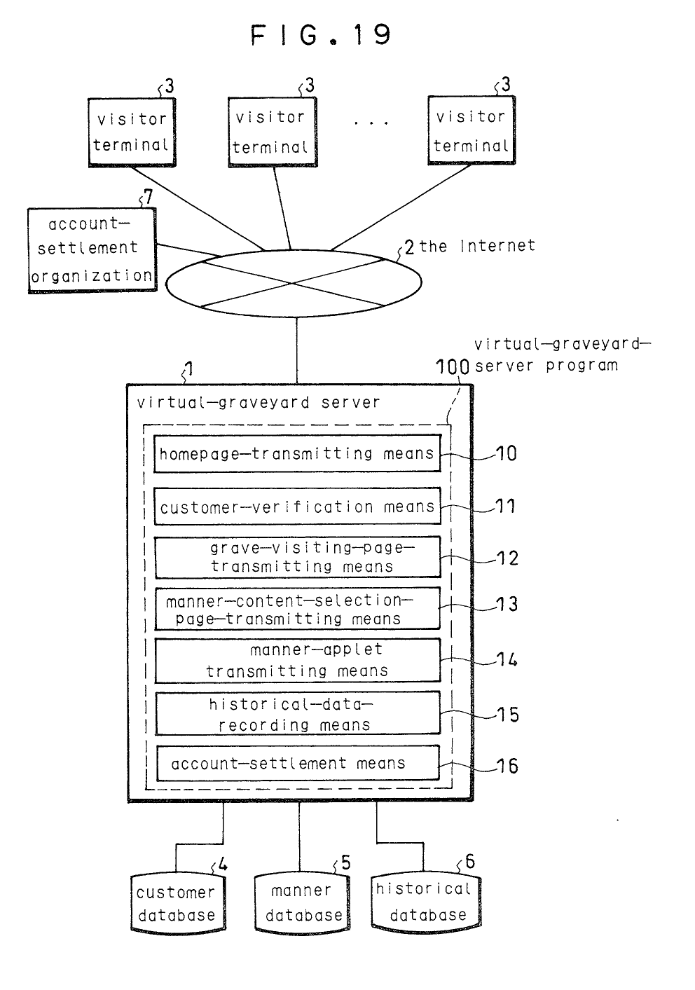

Referring to FIG. 17, the historical database 6 stores one or more historical-data records, one of which has each field of customer name, gravestone ID, visiting date, entry flag, grave-cleaning flags, incense-burning flags, votive-offering flags, sutra-chanting flags, the decedent displaying flags and total fee. Flags in field of various manners become on when manner applet corresponding to manner content is transmitted.

FIG. 18 is a flowchart of process of the virtual-graveyard server 1 in FIG. 1.

In operation, in order to visit a grave virtually by utilizing the virtual-grave-visiting system, a visitor accesses the virtual-graveyard server 1 from the visitor terminal 3 via the Internet 2.

Accessed from the visitor terminal 3 (step S101), the virtual-graveyard server 1 transmits the virtual-graveyard homepage shown in FIG. 2 by the homepage-transmitting means 10 to the visitor terminal 3 originally accessed (step S102). So long as it is not particularly mentioned, hereinafter “the visitor terminal 3” means the visitor terminal 3 which originally accessed to the virtual-graveyard server 1.

Seeing the virtual-graveyard homepage displayed by the visitor terminal 3, the visitor inputs a customer name and a gravestone ID and clicks the entry icon, whereupon the visitor terminal 3 transmits an entry request including the customer name and the gravestone ID to the virtual-graveyard server 1.

Receiving the entry request from the visitor terminal 3 (step S103), the virtual-graveyard server 1 verifies whether the visitor is one of registered customers or not by retrieving the customer name and the gravestone ID from the customer database 4 by the customer-verification means 11 (step S104) If the visitor is not one of registered customers, the virtual-graveyard server 1 refuses the entry request. On the other hand, when the visitor is one of registered customer, the virtual-graveyard server 1 makes a historical-data record and accounts entrance fee, and thereafter records it in the historical database 6 by the historical-data-recording means 15 (step S105). The reason for accounting the entrance fee is because the cost of using the grave-visiting page should be charged to the visitor even if he exits from the virtual graveyard without any manners.

Next, the virtual-graveyard server 1 retrieves a gravestone image from the customer database 4 and makes the grave-visiting page shown in FIG. 3, and thereafter transmits it to the visitor terminal 3 by the grave-visiting-page-transmitting means 12 (step S106).

Seeing the grave-visiting page displayed by the visitor terminal 3, the visitor clicks the grave-cleaning icon, whereupon the visitor terminal 3 transmits a grave-cleaning-content request to the virtual-graveyard server 1.

Receiving the grave-cleaning-content request from the visitor terminal 3 (step S108), the virtual-graveyard server 1 reads out grave-cleaning records from the grave-cleaning file 51, and makes the grave-cleaning-content-selection page shown in FIG. 4, and thereafter transmits it to the visitor terminal 3 by the manner-content-selection-page-transmitting means 13 (step S109).

Seeing the grave-cleaning-content-selection page displayed by the visitor terminal 3, the visitor clicks one of select icons, whereupon the visitor terminal 3 transmits a selection result of grave-cleaning contents to the virtual-graveyard server 1.

Receiving the selection result of grave-cleaning contents from the visitor terminal 3 (step S110), the virtual-graveyard server 1 retrieves one or more manner applets corresponding to the selection result of grave-cleaning contents from the grave-cleaning file 51, and thereafter transmits them to the visitor terminal 3 by the manner-applet-transmitting means 14 (step S111).

Receiving one or more manner applets for grave cleaning from the virtual-graveyard server 1, the visitor terminal 3 adds an image of a ladle to the gravestone image on the grave-visiting page (see FIG. 9).

After transmitting one or more manner applets for grave cleaning, the virtual-graveyard server 1 updates the historical-data record of the visitor in the historical database 6 so as to account grave-cleaning fee by the historical-data-recording means 15 (step S112).

Seeing the grave-visiting page displayed by the visitor terminal 3, the visitor clicks the incense-burning icon, whereupon the visitor terminal 3 transmits an incense-burning-content request to the virtual-graveyard server 1.

Receiving the incense-burning-content request from the visitor terminal 3 (step S108), the virtual-graveyard server 1 reads out incense-burning records from the incense-burning file 52, and makes the incense-burning-content-selection page shown in FIG. 5, and thereafter transmits it to the visitor terminal 3 by the manner-content-selection-page-transmitting means 13 (step S109).

Seeing the incense-burning-content-selection page displayed by the visitor terminal 3, the visitor clicks one of select icons, whereupon the visitor terminal 3 transmits a selection result of incense-burning contents to the virtual-graveyard server 1.

Receiving the selection result of incense-burning contents from the visitor terminal 3 (step S110), the virtual-graveyard server 1 retrieves one or more manner applets corresponding to the selection result of incense-burning contents from the incense-burning file 52, and thereafter transmits them to the visitor terminal 3 by the manner-applet-transmitting means 14 (step S111).

Receiving one or more manner applets for incense burning from the virtual-graveyard server 1, the visitor terminal 3 adds one or more images of incense sticks, candles and/or perfume to the gravestone image on the grave-visiting page (see FIG. 9).

After transmitting one or more manner applets for incense burning, the virtual-graveyard server 1 updates the historical-data record of the visitor in the historical database 6 so as to accounts incense-burning fee by the historical-data-recording means 15 (step S112).

Seeing the grave-visiting page displayed by the visitor terminal 3, the visitor clicks the votive-offering icon, whereupon the visitor terminal 3 transmits a votive-offering-content request to the virtual-graveyard server 1.

Receiving the votive-offering-content request from the visitor terminal 3 (step S108), the virtual-graveyard server 1 reads out votive-offering records from the votive-offering file 53, and makes the votive-offering-content-selection page shown in FIG. 6, and thereafter transmits it to the visitor terminal 3 by the manner-content-selection-page-transmitting means 13 (step S109).

Seeing the votive-offering-content-selection page displayed by the visitor terminal 3, the visitor clicks one of select icons, whereupon the virtual-graveyard server 1 transmits a selection result of votive-offering contents to the virtual-graveyard server 1.

Receiving the selection result of votive-offering contents from the visitor terminal 3 (step S110), the virtual-graveyard server 1 retrieves one or more manner applets corresponding to the selection result of votive-offering contents from the votive-offering file 53, and thereafter transmits them to the visitor terminal 3 by the manner-applet-transmitting means 14 (step S111).

Receiving one or more manner applets for votive offering from the virtual-graveyard server 1, the visitor terminal 3 adds one or more images of flowers, fruits and/or confectionery to the gravestone image on the grave-visiting page (see FIG. 9).

After transmitting one or more manner applets for votive offering, the virtual-graveyard server 1 updates the historical-data record of the visitor in the historical database 6 so as to account votive-offering fee by the historical-data-recording means 15 (step S112).

Seeing the grave-visiting page displayed by the visitor terminal 3, the visitor clicks the sutra-chanting icon, whereupon the visitor terminal 3 transmits a sutra-chanting-content request to the virtual-graveyard server 1.

Receiving the sutra-chanting-content request from the visitor terminal 3 (step S108), the virtual-graveyard server 1 reads out sutra-chanting records from the sutra-chanting file 54, and makes the sutra-chanting-content-selection page shown in FIG. 7, and thereafter transmits it to the visitor terminal 3 by the manner-content-selection-page-transmitting means 13 (step S109).

Seeing the sutra-chanting-content-selection page displayed by the visitor terminal 3, the visitor clicks one of select icons, whereupon the visitor terminal 3 transmits a selection result of sutra-chanting contents to the virtual-graveyard server 1.

Receiving the selection result of sutra-chanting contents from the visitor terminal 3 (step S110), the virtual-graveyard server 1 retrieves one or more manner applets corresponding to the selection result of sutra-chanting contents from the sutra-chanting file 54, and thereafter transmits them to the visitor terminal 3 by the manner-applet-transmitting means 14 (step S111).

Receiving one or more manner applets for sutra chanting from the virtual-graveyard server 1, the visitor terminal 3 adds one or more images of a back figure of a priest or the like to the gravestone image on the grave-visiting page (see FIG. 9).

After transmitting one or more manner applets for sutra chanting, the virtual-graveyard server 1 updates the historical-data record of the visitor in the historical database 6 so as to account sutra-chanting fee by the historical-data-recording means 15 (step S112).

Seeing the grave-visiting page displayed by the visitor terminal 3, the visitor clicks the decedent-displaying icon, whereupon the visitor terminal 3 transmits the decedent-displaying-content request to the virtual-graveyard server 1.

Receiving the decedent-displaying-content request from the visitor terminal 3 (step S108), the virtual-graveyard server 1 reads out the decedent-displaying records from the decedent files 41, and makes the decedent-displaying-content-selection page shown in FIG. 8, and thereafter transmits it to the visitor terminal 3 by the manner-content-selection-page-transmitting means 13 (step S109).

Seeing the decedent-displaying-content-selection page displayed by the visitor terminal 3, the visitor clicks one of select icons, whereupon the visitor terminal 3 transmits a selection result of the decedent-displaying contents to the virtual-graveyard server 1.

Receiving the selection result of the decedent-displaying contents from the visitor terminal 3 (step S110), the virtual-graveyard server 1 retrieves one or more manner applets corresponding to the selection result of the decedent-displaying contents from the decedent file 41, and thereafter transmits them to the visitor terminal 3 by the manner-applet-transmitting means 14 (step S111).

Receiving one or more manner applets for the decedent displaying from the virtual-graveyard server 1, the visitor terminal 3 opens the decedent-displaying window on the grave-visiting page (see FIG. 9).

After transmitting one or more manner applets for the decedent displaying, the virtual-graveyard server 1 updates the historical-data record of the visitor in the historical database 6 so as to account the decedent-displaying fee by the historical-data-recording means 15 (step S112).

Seeing the grave-visiting page displayed by the visitor terminal 3 after preparations of various manner applets(see FIG. 9), the visitor clicks the start icon, whereupon the visitor terminal 3 starts running of various manner applets in turn. As a result, various manners, such as grave cleaning, incense burning, votive offering and sutra chanting are virtually executed on the gravestone image in turn, and picture, movie, voice or/and others data are replayed in the decedent-displaying window.

After running of various manner applets for grave visiting, the visitor clicks the end icon on the grave-visiting page displayed by the visitor terminal 3, whereupon the visitor terminal 3 transmits an end request to the virtual-graveyard server 1.

Receiving the end request from the visitor terminal 3 (step S107), the virtual-graveyard server 1 transmits the virtual-graveyard homepage shown in FIG. 2 to the visitor terminal 3 (step S113).

Seeing the virtual-graveyard homepage displayed by the visitor terminal 3, the visitor clicks the exit icon on the virtual-graveyard homepage, whereupon the visitor terminal 3 transmits an exit request to the virtual-graveyard server 1.

Receiving the exit request from the visitor terminal 3 (step S114), the virtual-graveyard server 1 finishes services to the visitor terminal 3.

The grave-visiting agent watches historical-data records in the historical database 6 regularly. If a historical-data record of a customer has been updated, the grave-visiting agent proceeds to the real graveyard and visits the real grave of the customer. In detail, the grave-visiting agent executes various manners for grave visiting on the basis of the historical-data record in a manner similar to what was virtually executed on the grave-visiting page. After that, the grave-visiting agent dispatches a bill on the basis of a total fee of the historical-data record to the customer's address by mail or E-mail. In addition, if necessary, a photograph or a video of vicarious execution of grave visiting is mailed or E-mailed to the customer.

According to the first embodiment, a visitor does not have to visit a real grave in a real graveyard by utilizing the virtual-grave-visiting system, so that troubles and labors of coming and going to the graveyard become needless. In particular, the visitor's burden of grave visiting is reduced largely when the visitor cannot go out (for example, hospitalization) or when a graveyard is located in the remote place from the residence of the visitor (for example, isolated islands, foreign countries).

Although the grave-visiting agent proceeds to the real graveyard and visits the real grave of the customer in explanation of the first embodiment, vicarious execution of grave visiting by the grave-visiting agent becomes needless in case that the customer does not have a real grave.

In addition, only one virtual-graveyard server 1 is illustrated in FIG. 1, but the virtual-grave-visiting system of this invention can be expanded easily if grave-visiting homepages of two or more virtual-graveyard servers 1 are linked mutually with hypertext method.

(2) Second Embodiment

FIG. 19 is a block diagram of a virtual-grave-visiting system according to the second embodiment of this invention. This virtual-grave-visiting system is only different from the first embodiment shown in FIG. 1 in the point that the virtual-graveyard server 1 has an account-settlement means 16. It settles accounts on the basis of a historical-data record in the historical database 6 with an account-settlement organization 7, such as banks, credit companies or the like, that is connected to the virtual-graveyard server 1 via the Internet 2.

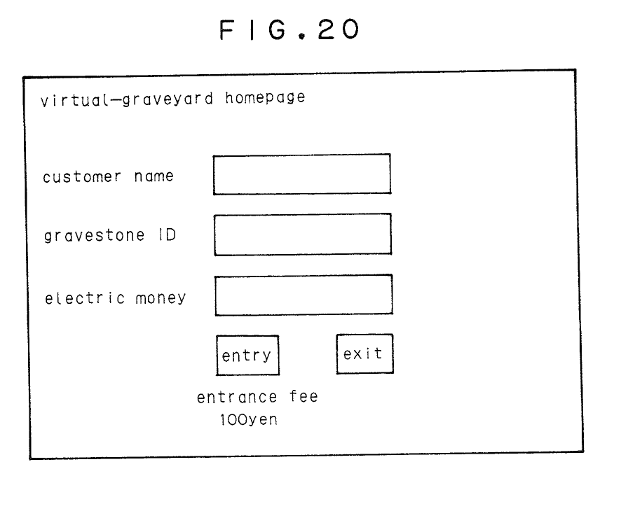

FIG. 20 is a screen view of the virtual-graveyard homepage displayed by a visitor terminal 3 when the virtual-graveyard server 1 is accessed from a visitor terminal 3 via the Internet 2. This virtual-graveyard homepage adds a field to input a password of electric money to the virtual-graveyard homepage of FIG. 2.

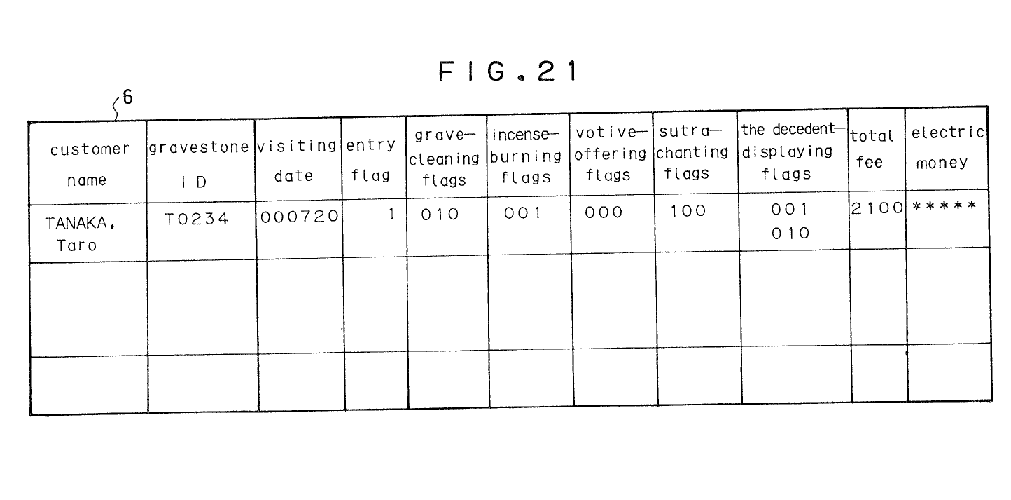

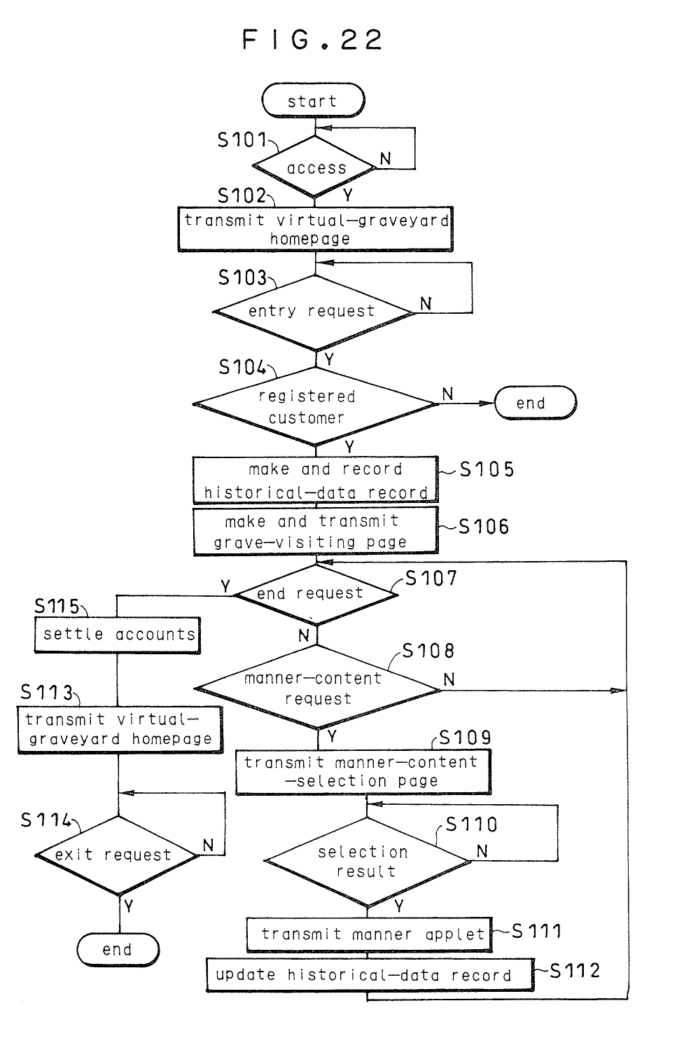

Referring to FIG. 21, a field to input a password of electric money is added to historical-data records in the historical database 6 in comparison with the same in FIG. 17. FIG. 22 is a flowchart of process of the virtual-graveyard server 1 in the second embodiment. This flowchart is only different from the same of FIG. 18 in point of adding step S115 between steps S107 and S113.

The operation of the second embodiment is only different from that of the first embodiment in point of settling accounts by electric money between the virtual-graveyard server 1 and the settlement organization 7. To be concrete, the account-settlement means 16 settles accounts on reference to a historical-data record in the historical database 6 (step S115) immediately after the end icon is clicked on the grave-visiting page of FIG. 3.

The detailed explanation of electric money will be omitted because it is not essential for this invention. Although account settlement is done by electric money in the second embodiment, an account settlement method other than electric money could be utilized. For example, credit could be utilized.

In the second embodiment, customers can be saved from troubles and labors of the periodical payment, and grave-visiting agents can be saved troubles and risks of fee collection, because account settlement is done by electric money on the spot.

By the way, in the second embodiment, grave visiting can be permitted not only to customers registered beforehand but also to the third party of non-registered because the account settlement is done on the spot. For example, far-off relatives, close friends or the like can visit a grave at any time by informing them of a customer name and a gravestone ID separately. Besides, it is possible that an unspecified number of the general public visit a grave of the celebrities by posting a customer name and a gravestone ID on the virtual-graveyard homepage. Furthermore, the completely virtual system could be built so as to collect only gravestone images of the celebrities, and it could be utilized as a celebrity-grave-retrieving system.

(3,4) Third and Fourth Embodiments

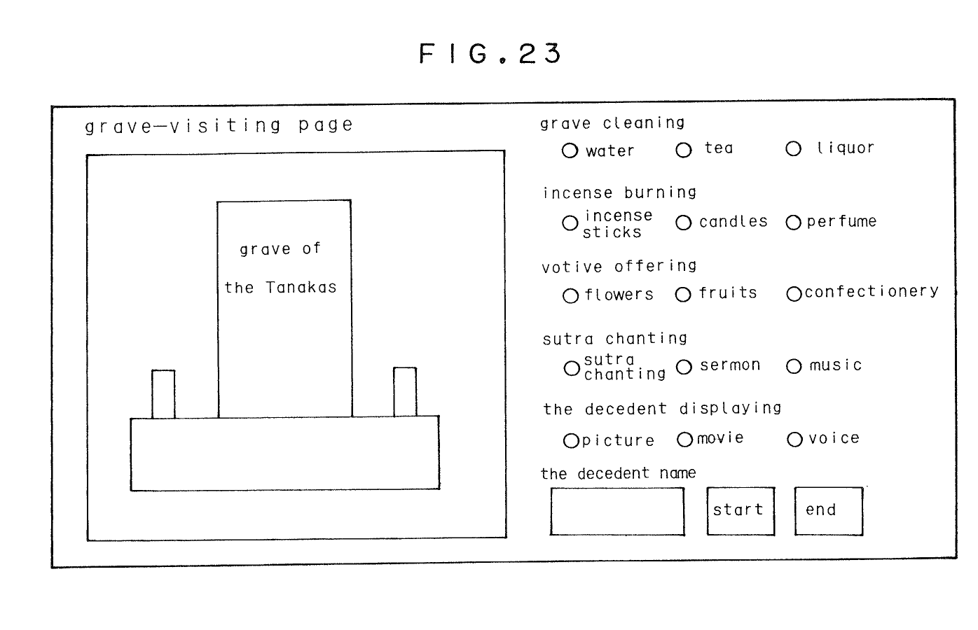

FIG. 23 shows a grave-visiting page displayed by a visitor terminal 3 in the third and the fourth embodiments of this invention. This grave-visiting page contains check boxes to select various manner contents and a field to input the decedent name in comparison with the same of FIG. 3.

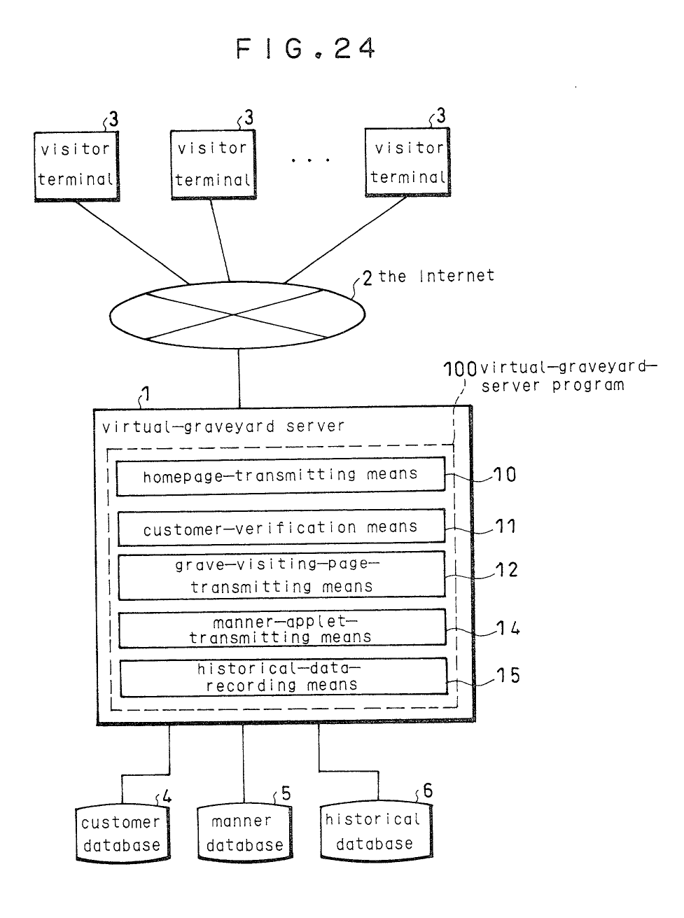

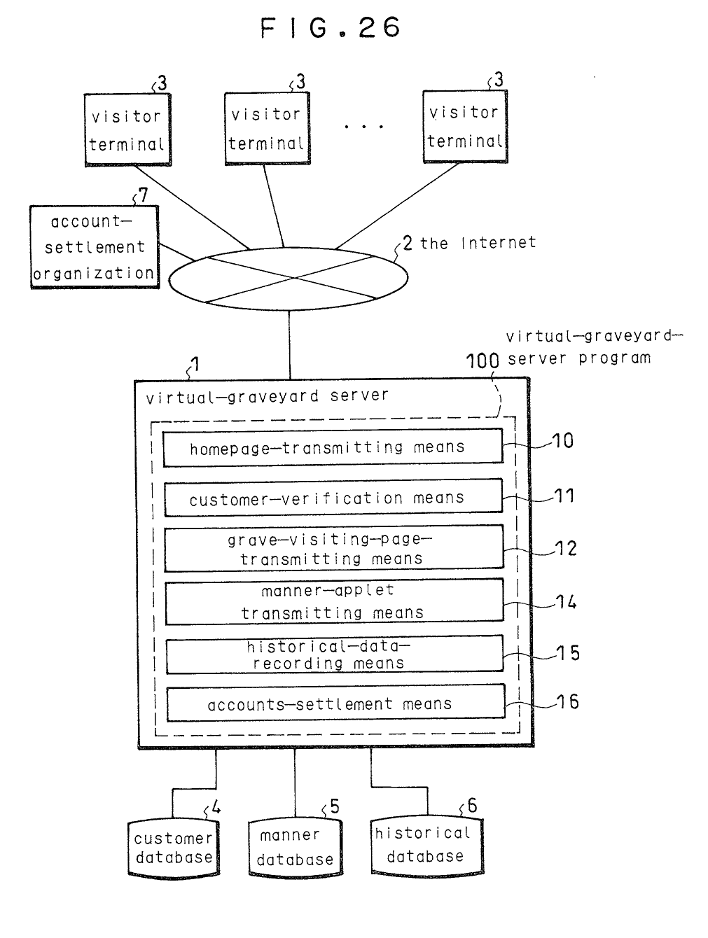

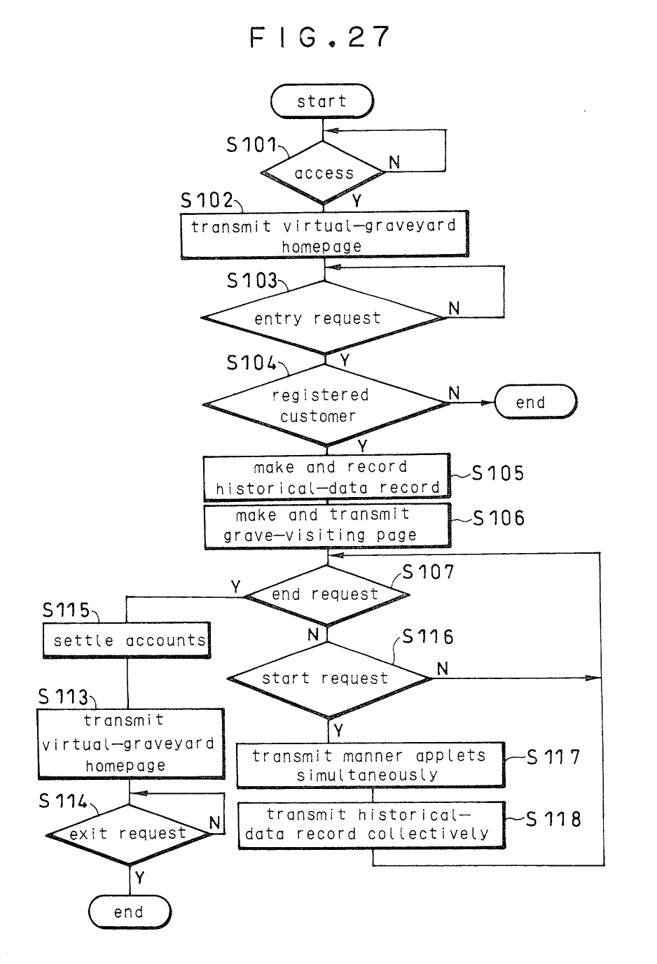

Referring to FIGS. 24 and 26, the manner-content-selection-page-transmitting means 13 in the virtual-graveyard server 1 becomes needless in the third and the fourth embodiments.

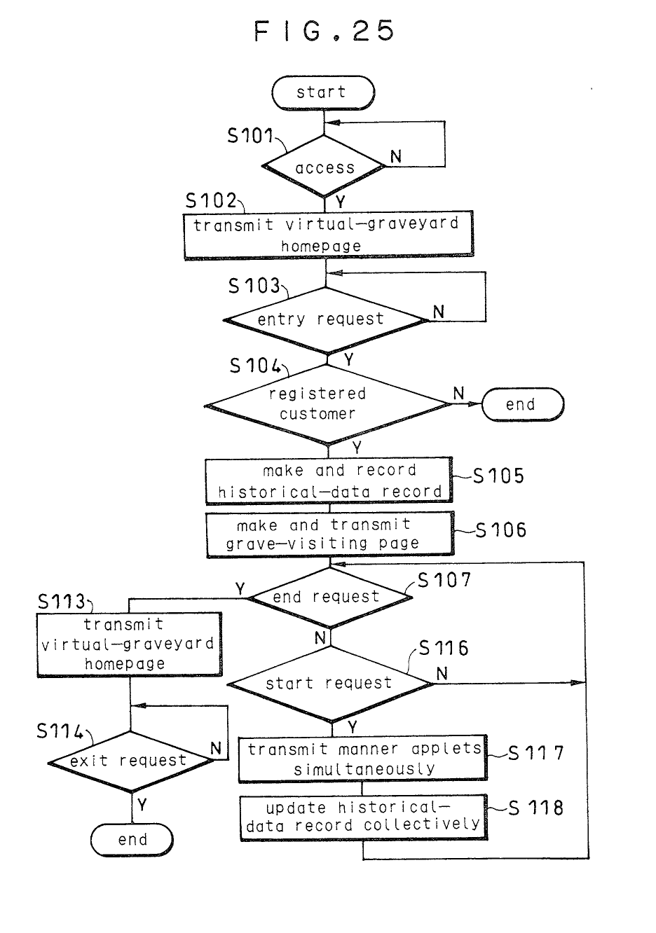

In flowcharts of process of the virtual-graveyard server 1 shown in FIGS. 25 and 27, steps S116, S117 and S118 replace steps S108-S112.

In operation, when the start icon is clicked after having checked one or more check boxes and having input the decedent name, a visitor terminal 3 transmits a start request including the selected manner contents and the decedent name to the virtual-graveyard server 1.

Receiving the start request from the visitor terminal 3 (step S116), the virtual-graveyard server 1 simultaneously transmits various manner applets corresponding to the selected manner contents to the visitor terminal 3 by retrieving them from the manner database 5 (step S117). After that, the virtual-graveyard server 1 collectively updates the historical-data record of the visitor in the historical database 6 in order that the simultaneous transmission of manner applets is reflected in an account (step S118).

Receiving the simultaneous transmission of the various manner applets, the visitor terminal 3 starts running of all the transmitted manner applets.

(5) Fifth Embodiment

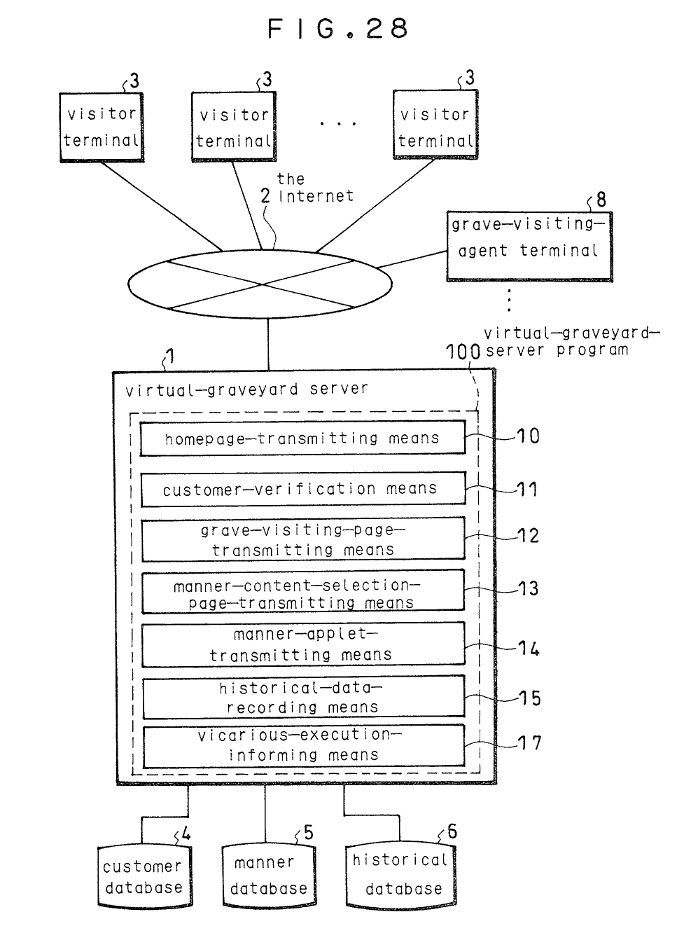

FIG. 28 is a block diagram of a virtual-grave-visiting system according to the fifth embodiment of this invention. This virtual-grave-visiting system is only different from the first embodiment shown in FIG. 1 in the point that a vicarious-execution-informing means 17 is added to the virtual-graveyard server 1. The vicarious-execution-informing means 17 informs vicarious execution of grave visiting by E-mail to a grave-visiting agent terminal 8 via the Internet 2 if a vicarious-execution flag of a historical-data record in the historical database 6 is on. Instead of E-mail, instant messages or the like can be utilized.

The grave-visiting agent terminal 8 is a terminal machine with a browser in a manner similar to the visitor terminal 3, and is connected to the Internet 2. Various kinds of information machines, such as personal computers, game machines, information household electric appliances, personal digital assistants, cellular phones or the like, can be used as the grave-visiting agent terminal 8. No dedicated application program except a browser is particularly needed.

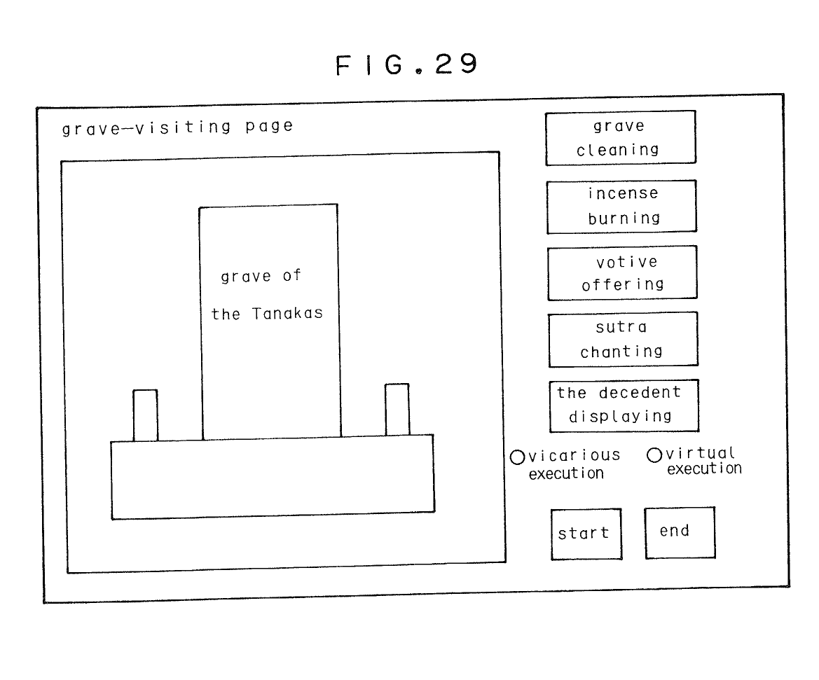

FIG. 29 is a screen view of a grave-visiting page displayed by the visitor terminal 3 in the fifth embodiment. This grave-visiting page contains additionally a vicarious-execution button and a virtual-execution button for selecting vicarious execution or virtual execution of grave visiting in comparison with the same of FIG. 3.

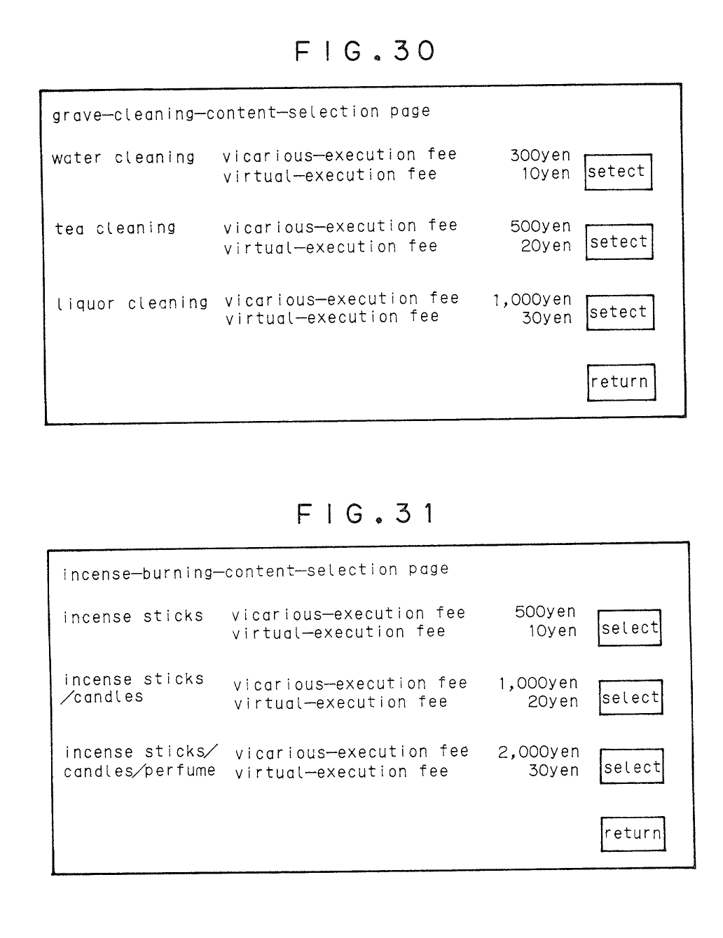

FIG. 30 is a screen view of a grave-cleaning-content-selection page displayed by a visitor terminal 3 when the grave-cleaning icon is clicked on the grave-visiting page of FIG. 29. This grave-cleaning-content-selection page additionally displays virtual-execution fees of water cleaning, tea cleaning and liquor cleaning in comparison with the same of FIG. 4.

FIG. 31 is a screen view of an incense-burning-content-selection page displayed by a visitor terminal 3 when the incense-burning icon is clicked on the grave-visiting page of FIG. 29. This incense-burning-content-selection page additionally displays virtual-execution fees of incense sticks, incense sticks/candles and incense sticks/candles/perfume in comparison with the same of FIG. 5.

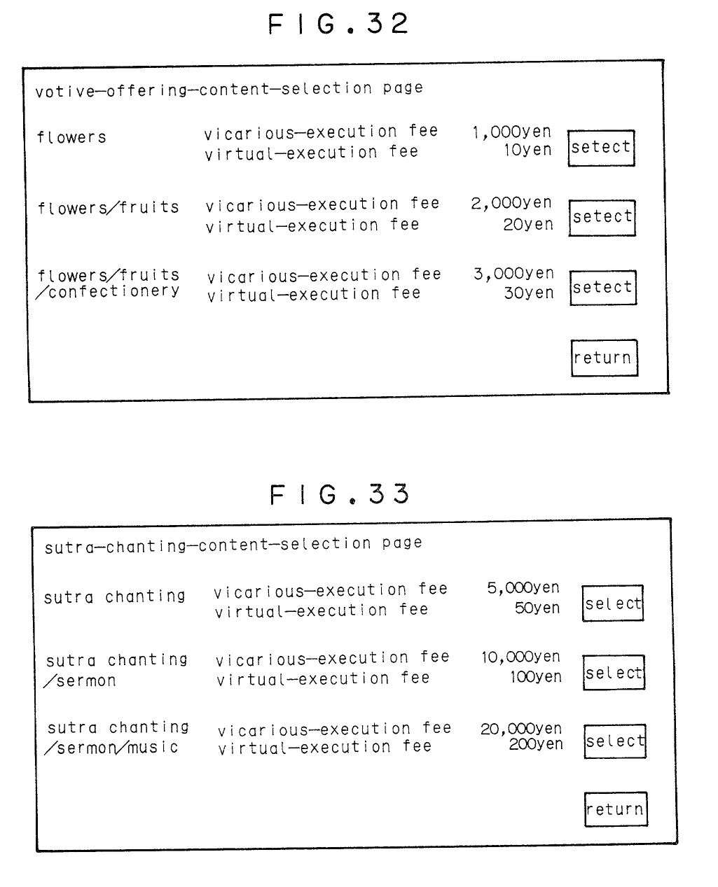

FIG. 32 is a screen view of a votive-offering-content-selection page displayed by a visitor terminal 3 when the votive-offering icon is clicked on the grave-visiting page of FIG. 29. This votive-offering-content-selection page additionally displays virtual-execution fees of flowers, flowers/fruits and flowers/fruits/confectionery in comparison with the same of FIG. 6.

FIG. 33 is a screen view of a sutra-chanting-content-selection page displayed by a visitor terminal 3 when the sutra-chanting icon is clicked on the grave-visiting page of FIG. 29. This sutra-chanting-content-selection page additionally displays virtual-execution fees of sutra chanting, sutra chanting/sermon and sutra chanting/sermon/music in comparison with the same of FIG. 7.

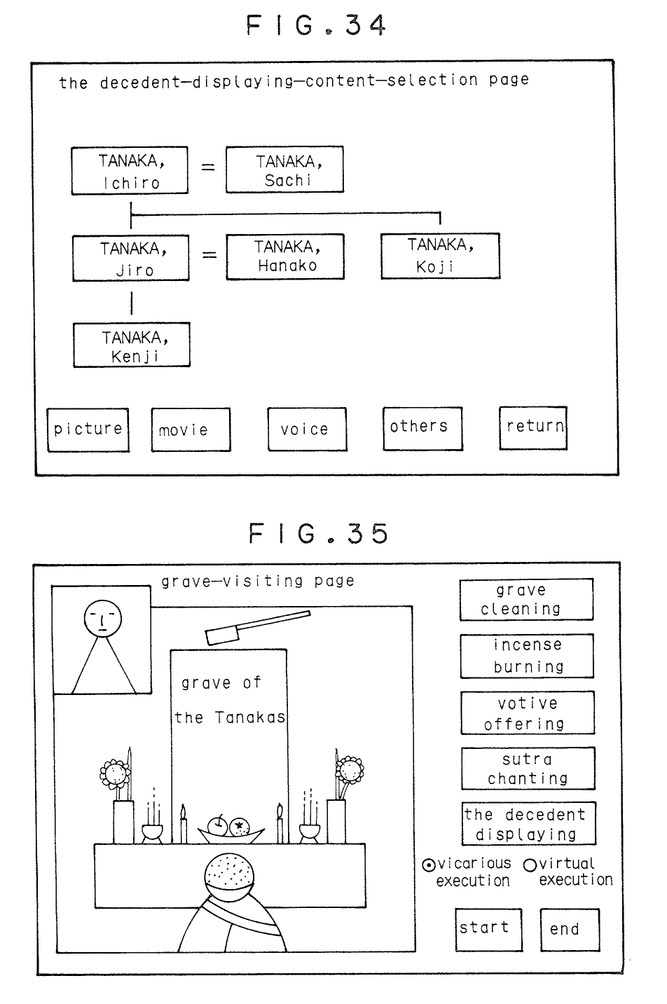

FIG. 34 is a screen view of the decedent-displaying-content-selection page displayed by a visitor terminal 3 when the decedent-displaying icon is clicked on the grave-visiting page of FIG. 29. The decedent-displaying-content-selection page contains the decedent name icons arranged like a family tree in addition to an picture icon, an movie icon, a voice icon, an others icon and a return icon.

FIG. 35 is a screen view of the grave-visiting page after various manners for grave visiting are selected with various manner icons on the grave-visiting page. In this grave-visiting page, the vicarious-execution button is selected in comparison with the same of FIG. 9.

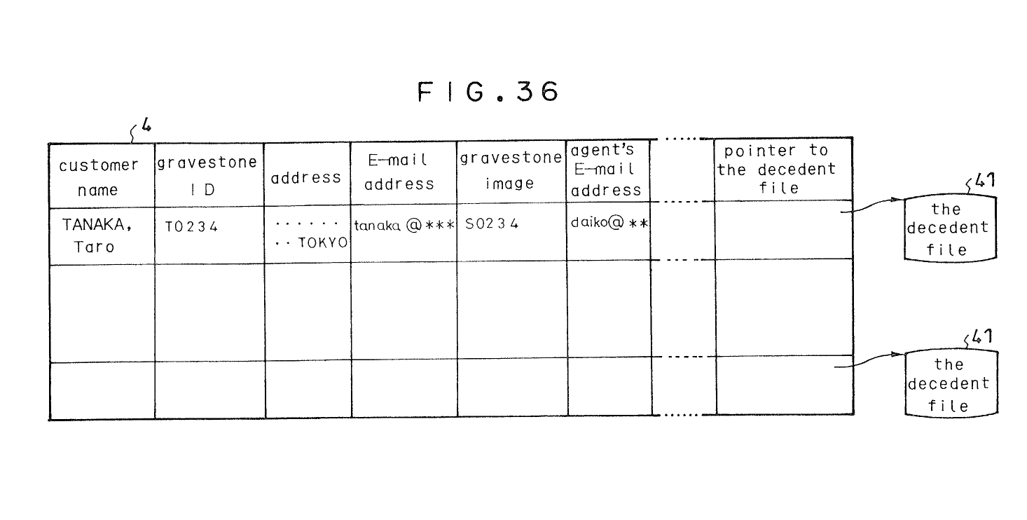

FIG. 36 shows customer records in the customer database 4 in FIG. 28. A field of agent's E-mail address is added to each customer record in comparison with the same of FIG. 10. The agent's E-mail address is appointed beforehand by every customer.

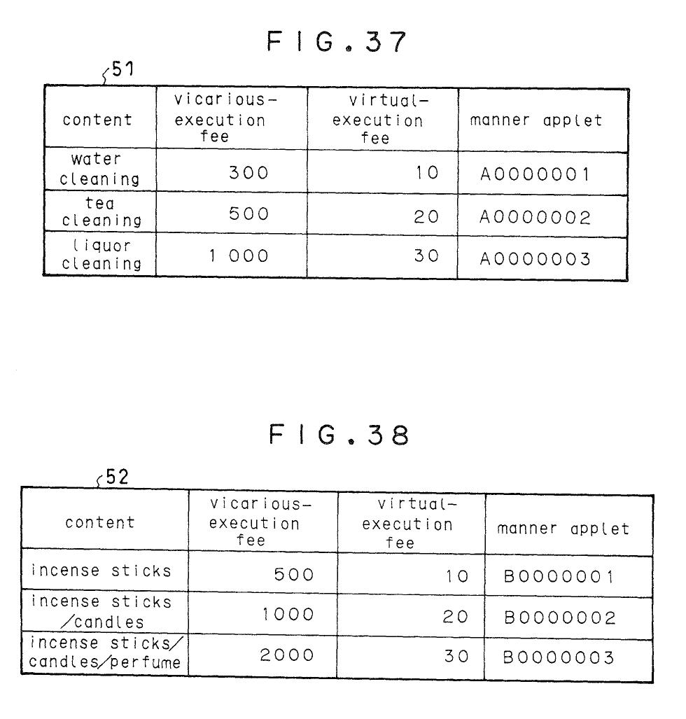

FIG. 37 shows grave-cleaning records of the grave-cleaning file 51 in the fifth embodiment. A field of virtual-execution fee is added to each grave-cleaning record in the grave-cleaning file 51 in comparison with the same of FIG. 13.

FIG. 38 shows incense-burning records of the incense-burning file 52 in the fifth embodiment. A field of virtual-execution fee is added to each incense-burning record in the incense-burning file 52 in comparison with the same of FIG. 14.

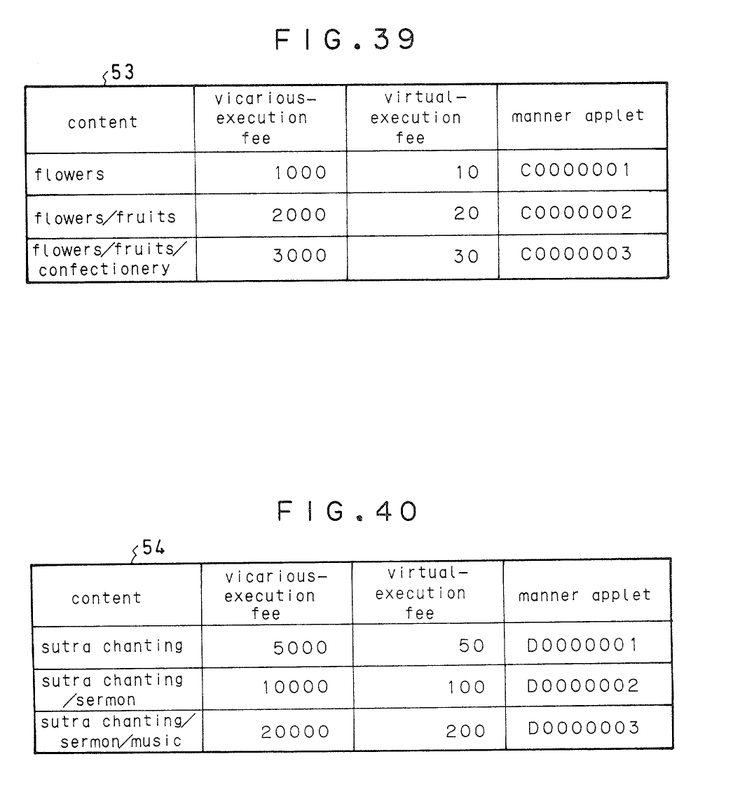

FIG. 39 shows votive-offering records of the votive-offering file 53 in the fifth embodiment. A field of virtual-execution fee is added to each votive-offering record in the votive-offering file 53 in comparison with the same of FIG. 15.

FIG. 40 shows sutra-chanting records of the sutra-chanting file 54 in the fifth embodiment. A field of virtual-execution fee is added to each sutra-chanting record in the sutra-chanting file 54 in comparison with the same of FIG. 16.

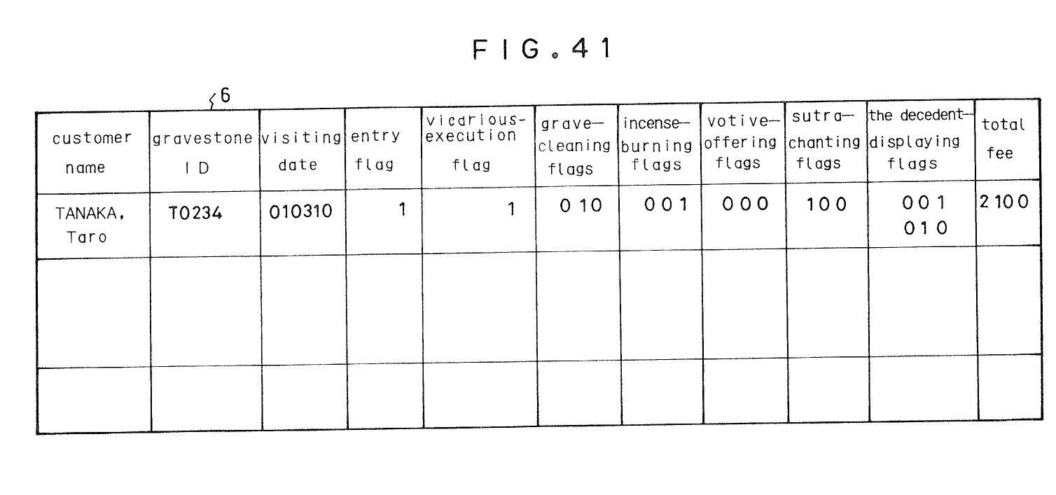

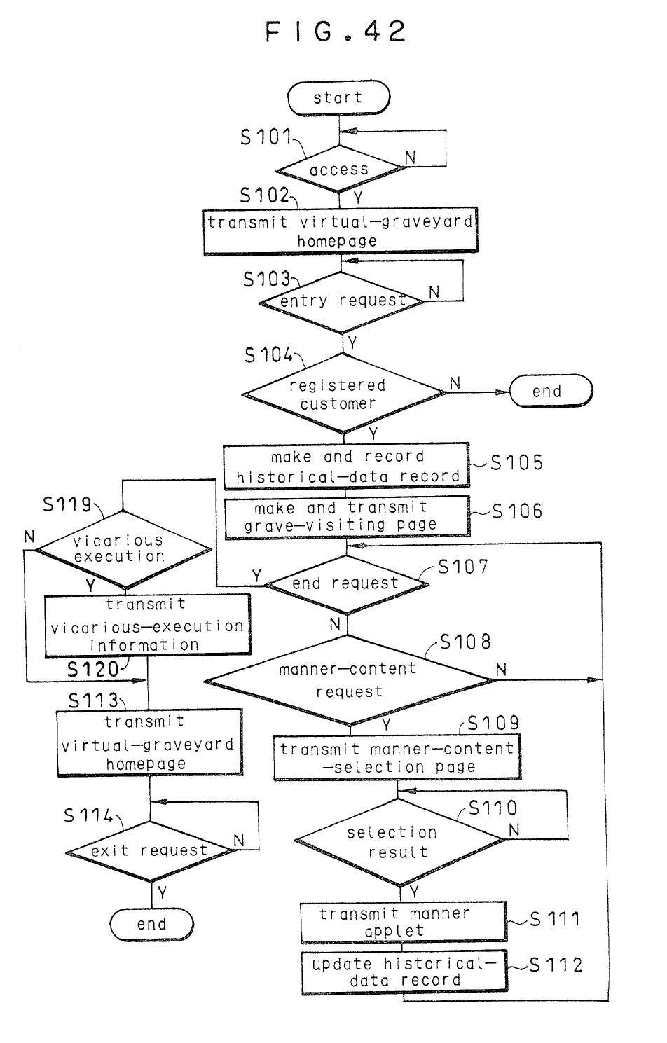

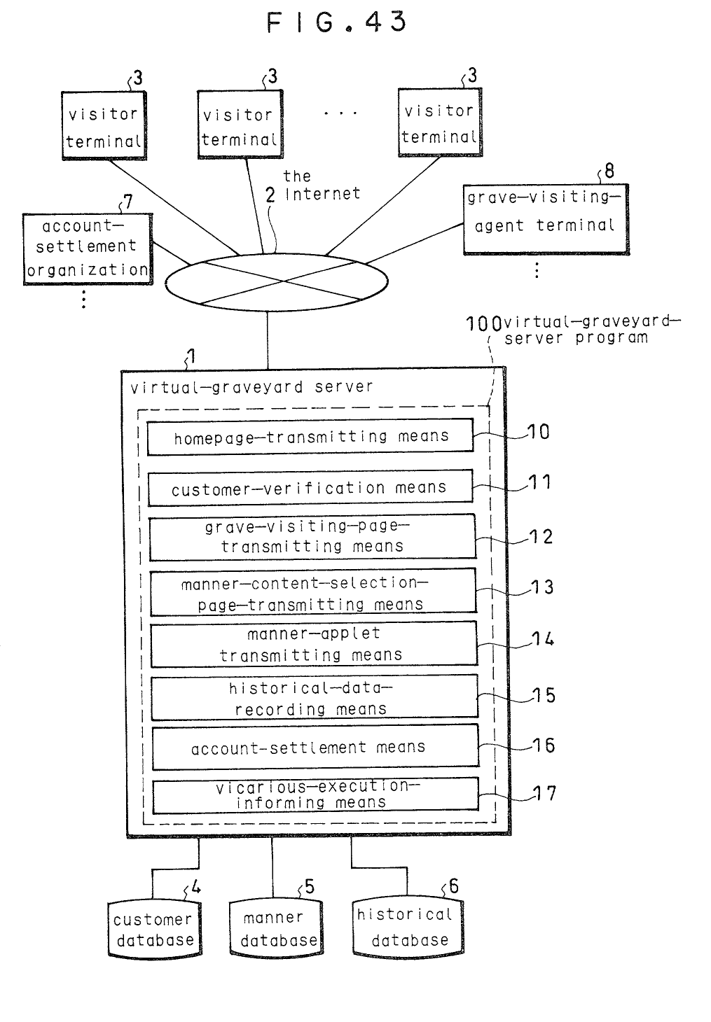

FIG. 41 shows historical-data records of the historical database in FIG. 28. A field of vicarious-execution flags is added to the historical-data record in comparison whit the same of FIG. 17.

FIG. 42 is a flowchart of process of the virtual-graveyard server 1 in FIG. 28.

The operation of the fifth embodiment is different from that of the first embodiment as follows.

After running various manner applets for grave visiting, the customer clicks the end icon on the grave-visiting page of FIG. 29, the visitor terminal 3 transmits an end request including a vicarious-execution flag to the grave-visiting server 1 via the Internet. The vicarious-execution flag is on when the vicarious-execution-select button is selected, while it is off when the vicarious-execution select button is not selected.

Receiving the end request from the visitor terminal 3, the virtual-graveyard server 1 is judged whether the vicarious-execution flag is on or off (step S119). If the vicarious-execution flag is on, the virtual-graveyard server 1 informs vicarious execution of grave visiting by E-mail on the basis of the historical-data record of the visitor in the historical database 6 to the vicarious-execution-agent terminal 8 via the Internet 2(step S120).

Receiving the E-mail informing vicarious execution of grave visiting by the grave-visiting-agent terminal 8, a grave-visiting agent visits the real grave of the visitor and vicariously executes various manners for grave visiting in a manner similar to what was virtually executed on the grave-visiting page on the basis of the information in the E-mail. After that, if necessary, the grave-visiting agent can send a photograph or a video of grave visiting by mail or E-mail to the visitor. In addition, a bill on the basis of the historical-data record is mailed to the address of the customer.

According to the fifth embodiment, the visitor can select vicarious execution of grave visiting on important days, such as an anniversary of the decedent, the Bon festival, the equinoctial week, while the visitor can select virtual execution of grave visiting on the day that is not important.

In addition, a customer appoints a desired grave-visiting agent beforehand because it becomes unnecessary that the grave-visiting agent should not be the same entity as the manager of the virtual-graveyard server 1. From another standpoint, the manager of the virtual-graveyard server 1 can entrust vicarious execution of grave visiting to the grave-visiting agent located near the real grave.

Grave-visiting agents can improve their services to customers by doing vicarious execution of grave visiting on the spot based on the information of vicarious execution of grave visiting.

(6) Sixth Embodiment

FIG. 43 is a block diagram of a virtual-grave-visiting system according to the sixth embodiment of this invention. This virtual-grave-visiting system is only different from the fifth embodiment shown in FIG. 28 in the point that the virtual-graveyard server 1 has an account-settlement means 16. It settles accounts with the account-settlement organization 7 connected to the virtual-graveyard server 1 via the Internet 2.

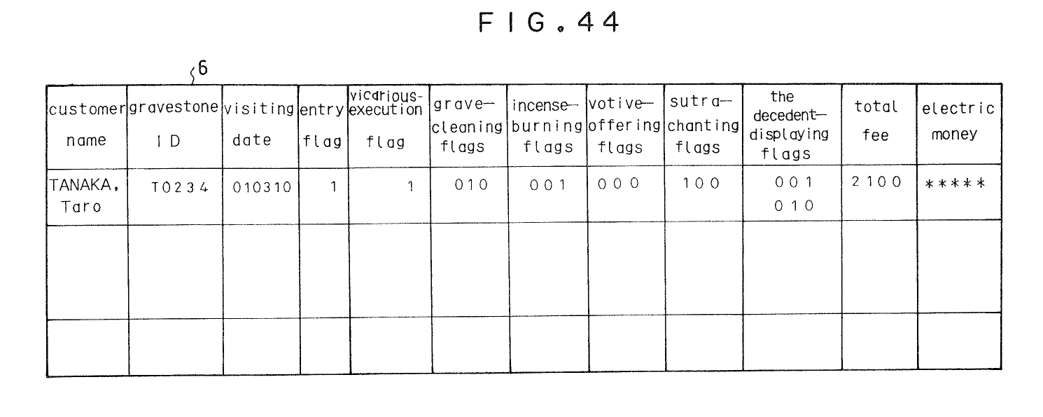

Referring to FIG. 44, a field to input a password of electric money is added to each historical-data record in the historical database 6 in comparison with the same in FIG. 41.

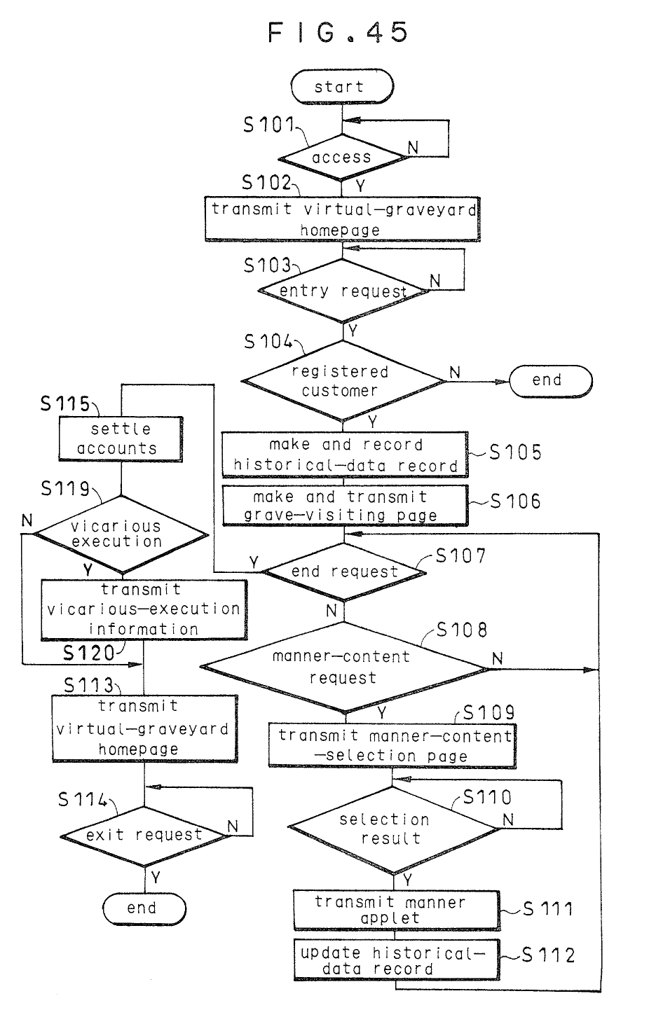

FIG. 45 is a flowchart of process of the virtual-graveyard server 1 in the sixth embodiment. This flowchart is only different from the same of FIG. 42 in point of adding step S115 between steps S107 and S119.

The operation of the sixth embodiment is only different from that of the fifth embodiment in point of settling accounts by electric money between the virtual-graveyard server 1 and the settlement organization 7. To be concrete, the account-settlement means 16 settles accounts on reference to a historical-data record in the historical database 6 (step S115) immediately after the end icon is clicked on the grave-visiting page of FIG. 35.

(7,8) Seventh and Eighth Embodiments

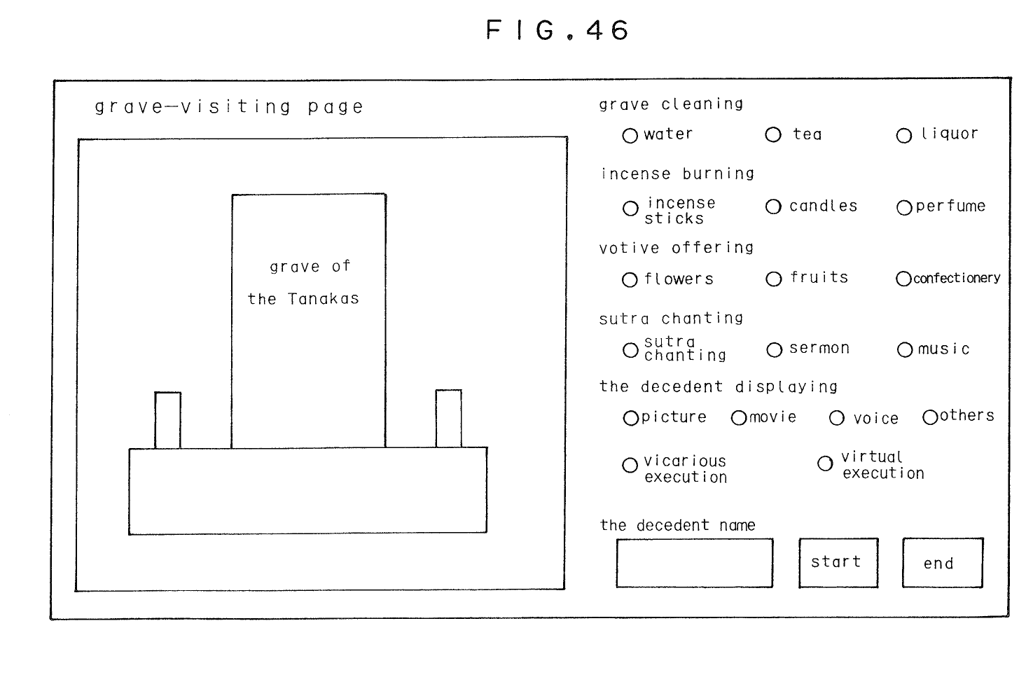

FIG. 46 is a screen view of a grave-visiting page displayed by the visitor terminal 3 in the seventh and eighth embodiments. This grave-visiting page contains additionally a vicarious-execution button and a virtual-execution button for selecting vicarious execution or virtual execution of grave visiting in comparison with the same of FIG. 23.

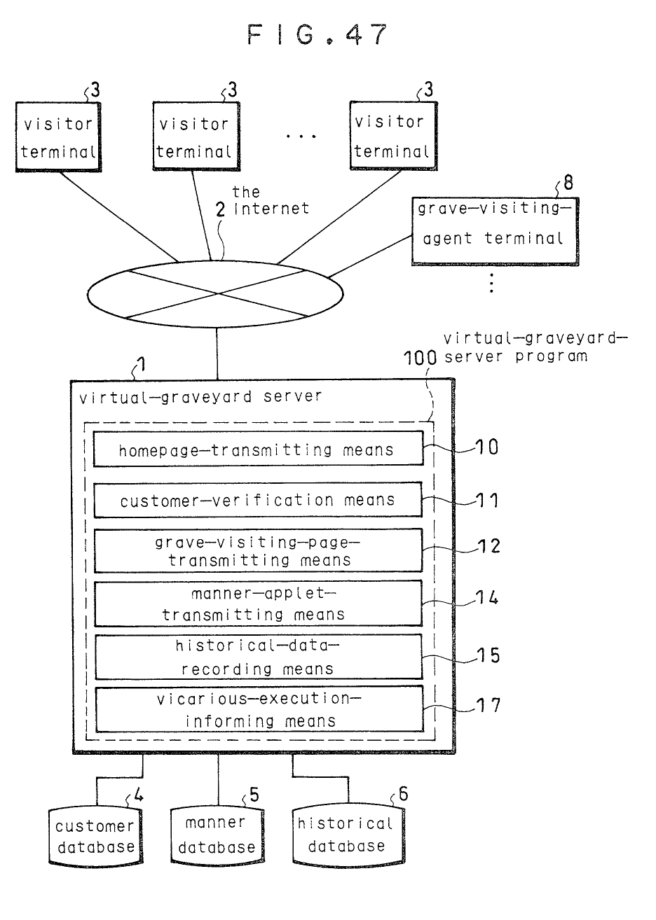

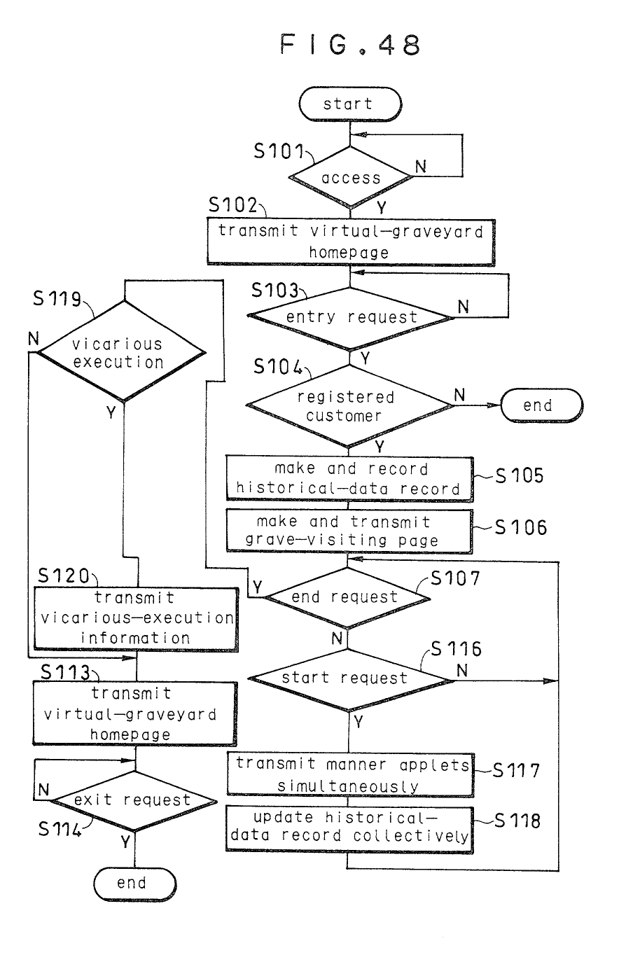

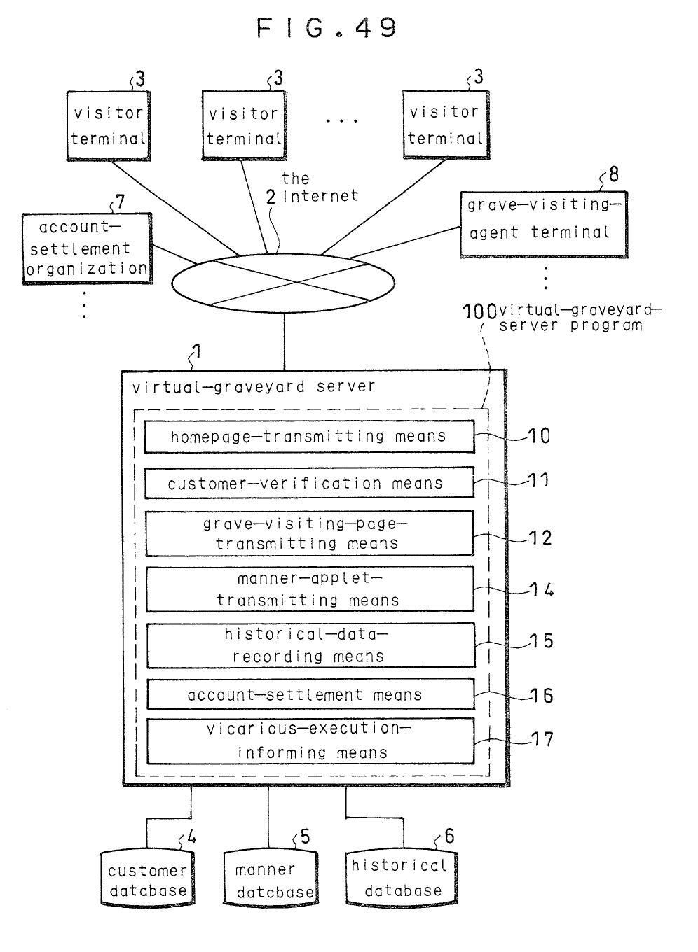

Referring to FIGS. 47 and 49, the manner-content-selection-page-transmitting means 13 in the virtual-graveyard server 1 becomes needless in the fifth and the sixth embodiments.

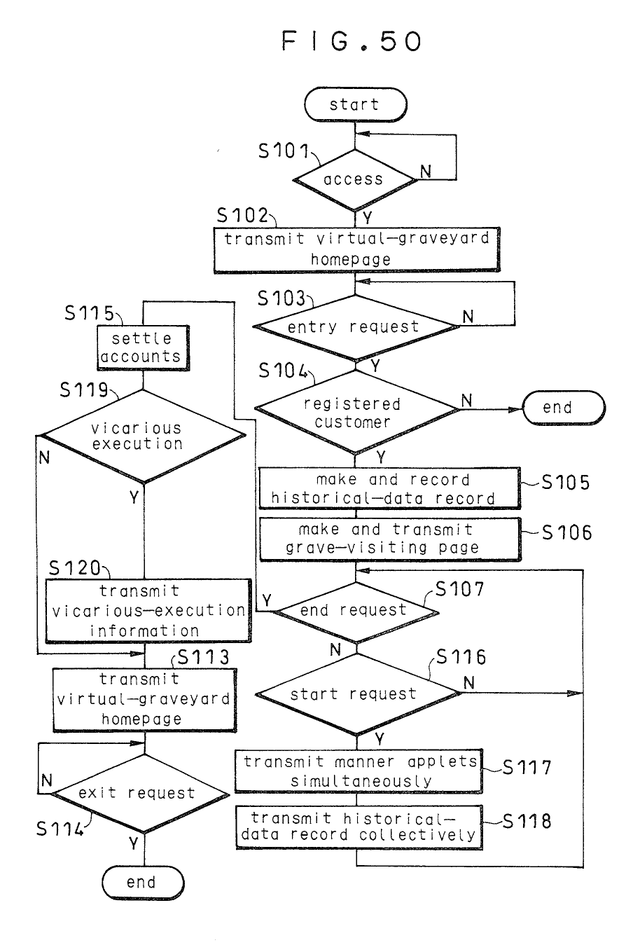

In flowcharts of process of the virtual-graveyard server 1 shown in FIGS. 48 and 50, steps S116, S117 and S118 replace steps S108-S112.

The operation of the seventh and the eighth embodiments is only different from that of the fifth and the sixth embodiments in point of simultaneous transmission of manner applets and collective updating of a historical-data record.

By the way, in above-mentioned embodiments, description is done in accordance with a gravestone and a graveyard of Buddhism. But even if a graveyard and a gravestone are based on the other religions, this invention can be applied at all in the same way.

Although the invention has been described in its preferred form with a certain degree of particularity, it is understood that the present disclosure of the preferred form has been changed in the details of construction and the combination and arrangement of parts may be restored to without departing from the spirit and the scope of the invention as hereinafter claimed.

What is claimed is:

1. A virtual-grave-visiting method comprising the steps of:
storing gravestone images to a virtual-graveyard server;
accessing said virtual-graveyard server from a visitor terminal via the Internet;
transmitting a grave-visiting page containing a desired gravestone image and a plurality of manner icons from said virtual-graveyard server to said visitor terminal via the Internet;
selecting one of manners for grave visiting by clicking one of manner icons on said grave-visiting page;
transmitting a manner-content-selection page containing a plurality of manner-content-select icons to said visitor terminal via the Internet when one of manner icons is clicked on said grave-visiting page;
selecting one of manner contents for grave visiting by clicking one of manner-content-select icons on said manner-content-selection page;
transmitting one or more manner applets corresponding to said selected manner content for grave visiting from said virtual-graveyard server to said visitor terminal via the Internet; and
running said transmitted manner applets on said grave-visiting page by said visitor terminal.

2. A virtual-grave-visiting method comprising the steps of:
storing gravestone images corresponding to real gravestones to a virtual-graveyard server;
accessing said virtual-graveyard server from a visitor terminal via the Internet;
transmitting a grave-visiting page containing a desired gravestone image, a plurality of manner icons and a vicarious-execution button from said virtual-graveyard server to said visitor terminal via the Internet;
selecting one of manners for grave visiting by clicking one of manner icons on said grave-visiting page;
transmitting a manner-content-selection page containing a plurality of manner-content-select icons to said visitor terminal via the Internet when one of manner icons is clicked on said grave-visiting page;
selecting one of manner contents for grave visiting by clicking one of said manner-content-select icons on said manner-content-selection page;
transmitting one or more manner applets corresponding to said selected manner contents for grave visiting from said virtual-graveyard server to said visitor terminal via the Internet;
running said transmitted manner applets on said grave-visiting page by said visitor terminal;
informing vicarious execution of grave visiting by E-mail to a grave-visiting agent terminal via the Internet if said vicarious-execution button is selected on said grave-visiting page; and
executing vicariously said selected manner contents for grave visiting to the real gravestone of said visitor on the basis of the information of vicarious execution of grave visiting by a grave-visiting agent.

3. A virtual-grave-visiting method comprising the steps of:
storing gravestone images to a virtual-graveyard server;
accessing said virtual-graveyard server from a visitor terminal via the Internet;
transmitting a grave-visiting page containing a desired gravestone image, a plurality of manner-content-select boxes and a start icon from said virtual-graveyard server to said visitor terminal via the Internet;
selecting one or more manner contents for grave visiting by checking one or more manner-content-select boxes on said grave-visiting page;
transmitting simultaneously one or more manner applets corresponding to said selected manner-content-select boxes for grave visiting from said virtual-graveyard server to said visitor terminal via the Internet; and
running said transmitted manner applets on said grave-visiting page by said visitor terminal.

4. A virtual-grave-visiting method comprising the steps of:
storing gravestone images corresponding to real gravestones to a virtual-graveyard server;
accessing said virtual-graveyard server from a visitor terminal via the Internet;
transmitting a grave-visiting page containing a desired gravestone image, a plurality of manner-content-select boxes, a vicarious-execution button and a start icon from said virtual-graveyard server to said visitor terminal via the Internet;
selecting one or more manner contents for grave visiting by checking one or more manner-content-select boxes on said grave-visiting page;
transmitting simultaneously one or more manner applets corresponding to said selected manner-content-select boxes from said virtual-graveyard server to said visitor terminal via the Internet;
running said transmitted manner applets on said grave-visiting page by said visitor terminal;
informing vicarious execution of grave visiting by E-mail to a grave-visiting agent terminal via the Internet if said vicarious-execution button is selected on said grave-visiting page; and
executing vicariously said selected manner contents for grave visiting to the real gravestone of said visitor on the basis of the information of vicarious execution of grave visiting by a grave-visiting agent.

5. A virtual-grave-visiting method as set forth in claims 1, 2, 3 or 4, further comprising the steps of:
accounting entrance fee on the basis of the transmission of said grave-visiting page; and
accounting manner fees on the basis of the transmission of said manner applets.

6. A virtual-grave-visiting system comprising:
a virtual-graveyard server connected to the Internet;
a customer database connected to said virtual-graveyard server, said customer database which stores information of registered customers and the decedent files recording pictures, movies and/or voices of the decedent worshiped by graves;
a manner database connected to said virtual-graveyard server, said manner database which stores a plurality of manner applets for grave visiting and manner fees each manners for grave visiting;
a historical database connected to said virtual-graveyard server, said historical database which stores historical-data records including account result of grave visiting; and
visitor terminals connected to said virtual-graveyard server via the Internet.

7. A virtual-grave-visiting system comprising:
a virtual-graveyard server connected to the Internet;
a customer database connected to said virtual-graveyard server, said customer database which stores information of registered customers and the decedent files recording pictures, movies and/or voices of the decedent worshiped by graves;
a manner database connected to said virtual-graveyard server, said manner database which stores a plurality of manner applets for grave visiting and manner fees each manners for grave visiting;
a historical database connected to said virtual-graveyard server, said historical database which stores historical-data records including account result of grave visiting;
visitor terminals connected to said virtual-graveyard server via the Internet; and
grave-visiting-agent terminals connected to said virtual-graveyard server via the Internet.

8. A virtual-grave-visiting system set forth in claims 6 or 7, further comprising:
an account-settlement organization connected to said virtual-graveyard server via the Internet, said account-settlement organization which settles accounts with said virtual-graveyard server.

9. A virtual-graveyard server comprising:
a customer database for storing information of registered customers;
a manner database for storing manner contents, manner fees and manner applets each manners for grave visiting;
a historical database for storing historical-data records including account result each grave visiting;
a homepage-transmitting means for transmitting a virtual-graveyard homepage to a visitor terminal via the Internet when a visitor accesses said virtual-graveyard server from said visitor terminal via the Internet;
a customer-verification means for verifying whether said visitor is one of registered customers by retrieving said customer database when grave visiting is requested on said virtual-graveyard homepage;
a grave-visiting-page-transmitting means for transmitting a grave-visiting page containing a gravestone image and a plurality of manner icons to said visitor terminal via the Internet by retrieving said customer database when said visitor is verified as one of registered customers by said customer-verification means;
a manner-content-selection-page-transmitting means for transmitting a manner-content-selection page containing a plurality of select icons to said visitor terminal via the Internet by retrieving said manner database when one of manner icons is clicked on said grave-visiting page;
a manner-applet-transmitting means for transmitting one or more manner applets to said visitor terminal via the Internet by retrieving said manner database when one of select icons is clicked on said manner-content-selection page; and
a historical-data-recording means for recording a historical-data record including account result in said historical database when said grave-visiting page is transmitted by said grave-visiting-page-transmitting means, and for updating said historical-data record when said manner applets are transmitted by said manner-applet-transmitting means.

10. A virtual-graveyard server comprising:
a customer database for storing information of registered customers;
a manner database for storing manner contents, manner fees and manner applets each manners for grave visiting;
a historical database for storing historical-data records including account result each grave visiting;
a homepage-transmitting means for transmitting a virtual-graveyard homepage to a visitor terminal via the Internet when a visitor accesses said virtual-graveyard server from said visitor terminal via the Internet;
a customer-verification means for verifying whether said visitor is one of registered customers by retrieving said customer database when grave visiting is requested on said virtual-graveyard homepage;
a grave-visiting-page-transmitting means for transmitting a grave-visiting page containing a gravestone image, a plurality of manner-content-select buttons and a start icon to said visitor terminal via the Internet by retrieving said customer database when said visitor is verified as one of registered customers by said customer-verification means;
a manner-applet-transmitting means for transmitting simultaneously one or more manner applets to said visitor terminal via the Internet by retrieving said manner database when said start icon is clicked after selecting one or more manners for grave visiting by checking one or more manner-content-select buttons on said grave-visiting page; and
a historical-data-recording means for recording a historical-data record including account result in said historical database when said grave-visiting page is transmitted by said grave-visiting-page-transmitting means, and for updating collectively said historical-data record when said manner applets are transmitted simultaneously by said manner-applet-transmitting means.

11. A virtual-graveyard server comprising:
a customer database for storing information of registered customers;
a manner database for storing manner contents, manner fees and manner applets each manners for grave visiting;
a historical database for storing historical-data records including account result each grave visiting;
a homepage-transmitting means for transmitting a virtual-graveyard homepage to a visitor terminal via the Internet when a visitor accesses said virtual-graveyard server from said visitor terminal via the Internet;
a customer-verification means for verifying whether said visitor is one of registered customers by retrieving said customer database when grave visiting is requested on said virtual-graveyard homepage;
a grave-visiting-page-transmitting means for transmitting a grave-visiting page containing a gravestone image, a plurality of manner icons and a vicarious-execution button to said visitor terminal via the Internet by retrieving said customer database when said visitor is verified as one of registered customers by said customer-verification means;
a manner-content-selection-page-transmitting means for transmitting a manner-content-selection page containing a plurality of select icons to said visitor terminal via the Internet by retrieving said manner database when one of manner icons is clicked on said grave-visiting page;
a manner-applet-transmitting means for transmitting one or more manner applets to said visitor terminal via the Internet by retrieving said manner database when one of select icons is clicked on said manner-content-selection page;
a historical-data-recording means for recording a historical-data record including account result in said historical database when said grave-visiting page is transmitted by said grave-visiting-page-transmitting means, and for updating said historical-data record when said manner applets are transmitted by said manner-applet-transmitting means; and
a vicarious-execution-informing means for informing vicarious execution of grave visiting on the basis of said historical-data record in said historical database by E-mail to a grave-visiting agent terminal via the Internet if said vicarious-execution button is selected on said grave-visiting page.

12. A virtual-graveyard server comprising:
a customer database for storing information of registered customers;
a manner database for storing manner contents, manner fees and manner applets each manners for grave visiting;
a historical database for storing historical-data records including account result each grave visiting;
a homepage-transmitting means for transmitting a virtual-graveyard homepage to a visitor terminal via the Internet when a visitor accesses said virtual-graveyard server from said visitor terminal via the Internet;
a customer-verification means for verifying whether said visitor is one of registered customers by retrieving said customer database when grave visiting is requested on said virtual-graveyard homepage;
a grave-visiting-page-transmitting means for transmitting a grave-visiting page containing a gravestone image, a plurality of manner-content-select buttons, a vicarious-execution button and a start icon to said visitor terminal via the Internet by retrieving said customer database when said visitor is verified as one of registered customers by said customer-verification means;
a manner-applet-transmitting means for transmitting simultaneously one or more manner applets to said visitor terminal via the Internet by retrieving said manner database when said start icon is clicked after selecting one or more manners of grave visiting by checking one or more manner-content-select buttons on said grave-visiting page;
a historical-data-recording means for recording a historical-data record including account result in said historical database when said grave-visiting page is transmitted by said grave-visiting-page-transmitting means, and for updating collectively said historical-data record when said manner applets are transmitted simultaneously by said manner-applet-transmitting means; and
a vicarious-execution-informing means for informing vicarious execution of grave visiting on the basis of said historical-data record in said historical database by E-mail to a grave-visiting agent terminal via the Internet if said vicarious-execution button is selected on said grave-visiting page.

13. A virtual-graveyard server as set forth in claims 9,10,11 or 12, further comprising:
an account-settlement means for settling accounts on the basis of said account result of said historical-data record in said historical database with an account-settlement organization that is connected to the virtual-graveyard server via the Internet.

14. A virtual-graveyard server as set forth in claims 9, 10, 11 or 12:
wherein said customer database has the decedent files storing pictures, movies and/or voices of the decedent worshiped by graves, contents of said decedent files which can be replayed in the decedent-displaying window opened on said grave-visiting page.

15. A program for a virtual-graveyard server comprising:
a homepage-transmitting means for transmitting a virtual-graveyard homepage to a visitor terminal via the Internet when a visitor accesses said virtual-graveyard server from said visitor terminal via the Internet;
a customer-verification means for verifying whether said visitor is one of registered customers by retrieving a customer database when grave visiting is requested on said virtual-graveyard homepage;
a grave-visiting-page-transmitting means for transmitting a grave-visiting page containing a gravestone image and a plurality of manner icons to said visitor terminal via the Internet by retrieving said customer database when said visitor is verified as one of registered customers by said customer-verification means;
a manner-content-selection-page-transmitting means for transmitting a manner-content-selection page containing a plurality of select icons to said visitor terminal via the Internet by retrieving a manner database when one of manner icons is clicked on said grave-visiting page;
a manner-applet-transmitting means for transmitting one or more manner applets to said visitor terminal via the Internet by retrieving said manner database when one of select icons is clicked on said manner-content-selection page; and
a historical-data-recording means for recording a historical-data record including account result in a historical database when said grave-visiting page is transmitted by said grave-visiting-page-transmitting means, and for updating said historical-data record when said manner applets are transmitted by said manner-applet-transmitting means.

16. A program for a virtual-graveyard server comprising:
a homepage-transmitting means for transmitting a virtual-graveyard homepage to a visitor terminal via the Internet when a visitor accesses said virtual-graveyard server from said visitor terminal via the Internet;
a customer-verification means for verifying whether said visitor is one of registered customers by retrieving a customer database when grave visiting is requested on said virtual-graveyard homepage;
a grave-visiting-page-transmitting means for transmitting a grave-visiting page containing a gravestone image, a plurality of manner-content-select buttons and a start icon to said visitor terminal via the Internet by retrieving said customer database when said visitor is verified as one of registered customers by said customer-verification means;
a manner-applet-transmitting means for transmitting simultaneously one or more manner applets to said visitor terminal via the Internet by retrieving a manner database when said start icon is clicked after selecting one or more manners for grave visiting by checking one or more manner-content-select buttons on said grave-visiting page; and
a historical-data-recording means for recording a historical-data record including account result in a historical database when said grave-visiting page is transmitted by said grave-visiting-page-transmitting means, and for updating collectively said historical-data record when said manner applets are transmitted simultaneously by said manner-applet-transmitting means.

17. A program for a virtual-graveyard server comprising:
a homepage-transmitting means for transmitting a virtual-graveyard homepage to a visitor terminal via the Internet when a visitor accesses said virtual-graveyard server from said visitor terminal via the Internet;
a customer-verification means for verifying whether said visitor is one of registered customers by retrieving a customer database when grave visiting is requested on said virtual-graveyard homepage;
a grave-visiting-page-transmitting means for transmitting a grave-visiting page containing a gravestone image, a plurality of manner icons and a vicarious-execution button to said visitor terminal via the Internet by retrieving said customer database when said visitor is verified as one of registered customers by said customer-verification means;
a manner-content-selection-page-transmitting means for transmitting a manner-content-selection page containing a plurality of select icons to said visitor terminal via the Internet by retrieving a manner database when one of manner icons is clicked on said grave-visiting page;
a manner-applet-transmitting means for transmitting one or more manner applets to said visitor terminal via the Internet by retrieving said manner database when one of select icons is clicked on said manner-content-selection page;
a historical-data-recording means for recording a historical-data record including account result in a historical database when said grave-visiting page is transmitted by said grave-visiting-page-transmitting means, and for updating said historical-data record when said manner applets are transmitted by said manner-applet-transmitting means; and
a vicarious-execution-informing means for informing vicarious execution of grave visiting on the basis of said historical-data record in said historical database by E-mail to a grave-visiting agent terminal via the Internet if said vicarious-execution button is selected on said grave-visiting page.

18. A program for a virtual-graveyard server comprising:
a homepage-transmitting means for transmitting a virtual-graveyard homepage to a visitor terminal via the Internet when a visitor accesses said virtual-graveyard server from said visitor terminal via the Internet;
a customer-verification means for verifying whether said visitor is one of registered customers by retrieving a customer database when grave visiting is requested on said virtual-graveyard homepage;
a grave-visiting-page-transmitting means for transmitting a grave-visiting page containing a gravestone image, a plurality of manner-content-select buttons, a vicarious-execution button and a start icon to said visitor terminal via the Internet by retrieving said customer database when said visitor is verified as one of registered customers by said customer-verification means;
a manner-applet-transmitting means for transmitting simultaneously one or more manner applets to said visitor terminal via the Internet by retrieving a manner database when said start icon is clicked after selecting one or more manners of grave visiting by checking one or more manner-content-select buttons on said grave-visiting page;
a historical-data-recording means for recording a historical-data record including account result in a historical database when said grave-visiting page is transmitted by said grave-visiting-page-transmitting means, and for updating collectively said historical-data record when said manner applets are transmitted simultaneously by said manner-applet-transmitting means; and
a vicarious-execution-informing means for informing vicarious execution of grave visiting on the basis of said historical-data record in said historical database by E-mail to a grave-visiting agent terminal via the Internet if said vicarious-execution button is selected on said grave-visiting page.

19. A program for a virtual-graveyard server as set forth in claims 15,16,17 or 18, further comprising:
an account-settlement means for settling accounts on the basis of said account result of said historical-data record in said historical database with an account-settlement organization that is connected to the virtual-graveyard server via the Internet.
